(19) United States
(12) Patent Application Publication
(10) Pub. No.: US 2013/0025071 A1
(43) Pub. Date: Jan. 31, 2013

(54) MULTIPURPOSE HAND HELD TOOLS

(71) Applicant: Shane Keng, Marietta, GA (US)

(72) Inventor: Shane Keng, Marietta, GA (US)

(73) Assignee: MULTITASKER TOOLS LLC, Marietta, GA (US)

(21) Appl. No.: 13/557,587

(22) Filed: Jul. 25, 2012

Related U.S. Application Data
(60) Provisional application No. 61/511,313, filed on Jul. 25, 2011.
(60) Provisional application No. 61/548,482, filed on Oct. 18, 2011.

(51) Int. Cl. B25F 1/04; B25B 7/22; B25G 1/08; B25F 1/00

(52) U.S. Cl. 7/118; 7/167; 7/138; 7/151; 7/165; 7/166; 7/128

(57) ABSTRACT

A multipurpose hand held tool includes a handle and one or more tools. The multipurpose tool may include an inletted recess defined in the handle, and an accessory tool retained within the inletted recess. The multipurpose tool also may include a rotatable tool and a locking mechanism for locking the rotatable tool in multiple positions. The multipurpose tool further may include a compact spanner wrench rotatably connected to the handle. The multipurpose tool may include a knife assembly detachably connected to the handle. The multipurpose tool also may include a ratcheting bit driver located within the handle. The multipurpose tool further may include a multi-layered plier head. The multipurpose may include a hybrid bearing system. The multipurpose tool also may include a flashlight detachably coupled to the handle. In this manner, the multipurpose tool may incorporate multiple tools and accessories for completing various tasks.

### CROSS-REFERENCE TO RELATED APPLICATIONS

The present application claims the benefit of U.S. Provisional Patent Application No. 61/511,313, filed on Jul. 25, 2011, and U.S. Provisional Patent Application No. 61/548,482, filed on Oct. 18, 2011, which are hereby incorporated in their entirety.

### FIELD OF THE DISCLOSURE

The present application relates generally to hand held tools and more particularly to multipurpose hand held tools and accessories.

### BACKGROUND

Traditional multipurpose hand held tools combine various hand tools, instruments, and accessories in a compact and portable unit. For example, a multipurpose tool may include a knife blade, a saw blade, a file, a screwdriver, a hook, tweezers, scissors, and other commonly used tools. Certain multipurpose tools may combine different component tools and accessories that are all useful for a specific task or activity, such as cleaning a firearm, working in a shop, or camping. Many multipurpose tools have a folding configuration that allows a component tool to be rotated from a storage position to a deployed position. Such multipurpose tools may also include a locking mechanism for holding the component tool in the storage position or the deployed position. Other multipurpose tools may include a retention or coupling mechanism for retaining a detachable tool or accessory.

As the tool needs and desires of consumers evolve, there is a continuing demand for an improved multipurpose tool that combines more component tools and accessories in a single unit without the overall tool becoming too bulky to carry or too cumbersome to operate. Additionally, with regards to folding multipurpose tools, there is a desire to provide an improved locking mechanism that allows a component tool to be locked at different positions relative to a frame or handle of a multipurpose tool. Furthermore, there is a desire to provide an improved retention or coupling mechanism for incorporating detachable tools and accessories into a multipurpose tool. Such improvements would enable a user to complete more tasks quickly and safely, while also enhancing overall ease of use of a multipurpose tool.

### BRIEF DESCRIPTION OF THE DRAWINGS

The detailed description is set forth with reference to the accompanying drawings. The use of the same reference numerals indicates similar or identical items. Various embodiments may utilize elements and/or components other than those illustrated in the drawings and some elements and/or components may not be present in various embodiments. Throughout this disclosure, depending on the context, singular and plural terminology may be used interchangeably.

FIG. 1 depicts a front view of an example multipurpose hand held tool in accordance with one or more embodiments of the disclosure, wherein component tools are shown in a storage position.

FIG. 2 depicts a front view of the example multipurpose hand held tool in accordance with one or more embodiments of the disclosure, wherein component tools are shown in a deployed position.

FIG. 3 depicts a perspective view of the example multipurpose hand held tool in accordance with one or more embodiments of the disclosure, wherein component tools are shown in the storage position.

FIG. 4 depicts a perspective view of the example multipurpose hand held tool in accordance with one or more embodiments of the disclosure, wherein component tools are shown in the deployed position.

FIG. 5 depicts a perspective view of the example multipurpose hand held tool in accordance with one or more embodiments of the disclosure, wherein component tools are shown in the deployed position.

FIG. 6 depicts a perspective exploded view of the example multipurpose hand held tool in accordance with one or more embodiments of the disclosure.

FIG. 7 depicts a perspective exploded view of the example multipurpose hand held tool in accordance with one or more embodiments of the disclosure.

FIG. 8 depicts a front view of an example multipurpose hand held tool in accordance with one or more embodiments of the disclosure, wherein component tools are shown in a storage position.

FIG. 9 depicts a perspective view of a locking mechanism of the example multipurpose hand held tool in accordance with one or more embodiments of the disclosure, wherein component tools are shown in the storage position.

FIG. 10 depicts a perspective view of the locking mechanism of the example multipurpose hand held tool in accordance with one or more embodiments of the disclosure, wherein a component tool is shown in a first deployed position.

FIG. 11 depicts a perspective view of the locking mechanism of the example multipurpose hand held tool in accordance with one or more embodiments of the disclosure, wherein the component tool is shown in a second deployed position.

FIG. 12 depicts a top view of the example multipurpose hand held tool in accordance with one or more embodiments of the disclosure, wherein the component tool is shown in the storage position.

FIG. 13 depicts a perspective view of a component tool of the example multipurpose hand held tool in accordance with one or more embodiments of the disclosure, wherein the component tool is shown in a deployed position.

FIG. 14 depicts a top view of a component tool of the example multipurpose hand held tool in accordance with one or more embodiments of the disclosure, wherein the component tool is shown in a deployed position.

FIG. 15 depicts a top view of a component tool of the example multipurpose hand held tool in accordance with one or more embodiments of the disclosure, wherein the component tool is shown in the deployed position and engaging a castle nut.

FIG. 16 depicts a perspective view of an example multipurpose hand held tool in accordance with one or more embodiments of the disclosure, wherein a component assembly is detached from the remainder of the multipurpose tool.

FIG. 17 depicts a perspective view of the example multipurpose hand held tool in accordance with one or more embodiments of the disclosure, wherein the component assembly is detached from the remainder of the multipurpose tool.

FIG. 18 depicts a front view of the example multipurpose hand held tool in accordance with one or more embodiments of the disclosure, wherein the component assembly is attached to the remainder of the multipurpose tool, and the component assembly is in a deployed position.

FIG. 19 depicts a front view of the example multipurpose hand held tool in accordance with one or more embodiments of the disclosure, wherein the component assembly is attached to the remainder of the multipurpose tool, and the component assembly is in a deployed position.

FIG. 20 depicts a perspective view of the example multipurpose hand held tool in accordance with one or more embodiments of the disclosure, wherein the component assembly is attached to the remainder of the multipurpose tool, and the component assembly is in a deployed position.

FIG. 21 depicts a perspective view of the example multipurpose hand held tool in accordance with one or more embodiments of the disclosure, wherein the component assembly is attached to the remainder of the multipurpose tool, and the component assembly is in a deployed position.

FIG. 22 depicts a perspective exploded view of the component assembly and a handle of the example multipurpose hand held tool in accordance with one or more embodiments of the disclosure.

FIG. 23 depicts a perspective exploded view of a handle of the example multipurpose hand held tool in accordance with one or more embodiments of the disclosure.

FIG. 24 depicts a perspective exploded view of a plier head assembly of the example multipurpose hand held tool in accordance with one or more embodiments of the disclosure.

FIG. 25 depicts a perspective exploded view of a plier head assembly of the example multipurpose hand held tool in accordance with one or more embodiments of the disclosure.

FIG. 26 depicts a front view of an example multipurpose hand held tool in accordance with one or more embodiments of the disclosure, wherein handles of the multipurpose tool are in an open position.

FIG. 27 depicts a back view of the example multipurpose hand held tool in accordance with one or more embodiments of the disclosure, wherein the handles are in the open position.

FIG. 28 depicts a perspective view of the example multipurpose hand held tool in accordance with one or more embodiments of the disclosure, wherein the handles are in the open position.

FIG. 29 depicts a perspective view of the example multipurpose hand held tool in accordance with one or more embodiments of the disclosure, wherein the handles are in the open position.

FIG. 30 depicts a back view of the example multipurpose hand held tool in accordance with one or more embodiments of the disclosure, wherein the handles are in a closed position.

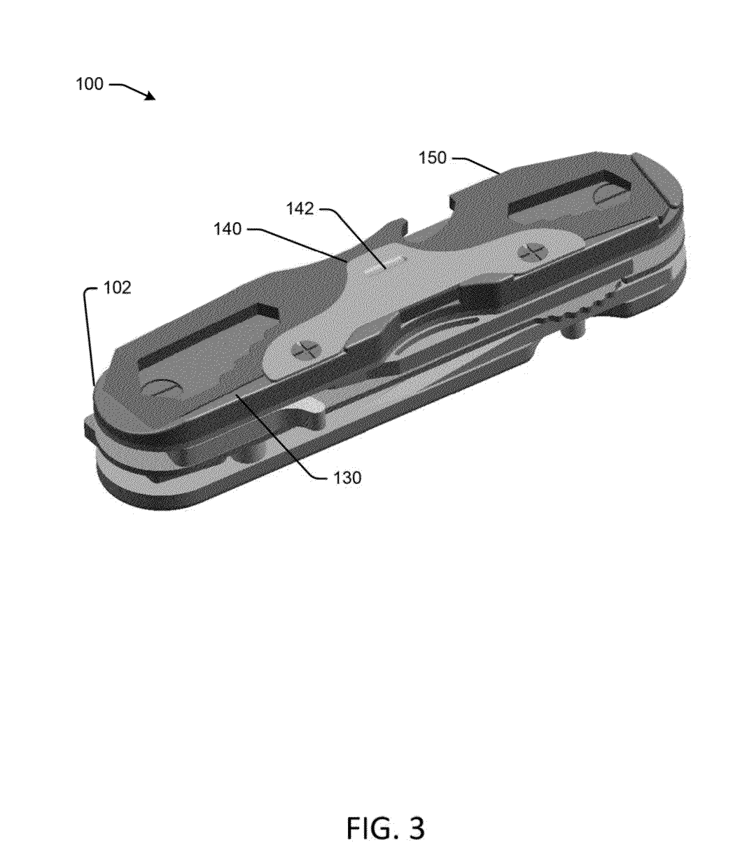

FIG. 3I depicts a perspective view of the example multipurpose hand held tool in accordance with one or more embodiments of the disclosure, wherein the handles are in the closed position.

FIG. 32 depicts a perspective view of the example multipurpose hand held tool in accordance with one or more embodiments of the disclosure, wherein the handles are in the closed position.

FIG. 33 depicts a front view of the example multipurpose hand held tool in accordance with one or more embodiments of the disclosure, wherein the handles are in the closed position and component tools are in a deployed position.

FIG. 34 depicts a perspective view of the example multipurpose hand held tool in accordance with one or more embodiments of the disclosure, wherein the handles are in the closed position and the component tools are in a deployed position.

FIG. 35 depicts an exploded perspective view of a handle, a coupling mechanism, and a detachable accessory of the example multipurpose hand held tool in accordance with one or more embodiments of the disclosure.

FIG. 36 depicts an exploded perspective view of the handle, the coupling mechanism, and the detachable accessory of the example multipurpose hand held tool in accordance with one or more embodiments of the disclosure.

FIG. 37 depicts an exploded perspective view of a plier head assembly of the example multipurpose hand held tool in accordance with one or more embodiments of the disclosure.

FIG. 38 depicts an exploded perspective view of the plier head assembly of the example multipurpose hand held tool in accordance with one or more embodiments of the disclosure.

### DETAILED DESCRIPTION OF THE DISCLOSURE

### Overview

The present disclosure includes various examples of multipurpose hand held tools that address one or more of the above-mentioned areas of improvement. Specifically, one or more of the examples may include component tools or accessories that are not provided in existing multipurpose tools. Additionally, one or more of the examples may provide component tools or accessories in a novel configuration. One or more of the examples may include an improved locking mechanism that allows a component tool to be locked in different positions relative to a frame or handle of a multipurpose tool. Furthermore, one or more of the examples may include an improved retention mechanism for incorporating detachable tools and accessories into a multipurpose tool. One or more of the examples also may include an improved coupling mechanism for incorporating and activating detachable tools and accessories. Accordingly, the various examples disclosed may enable a user to complete more tasks quickly and safely, while also enhancing overall ease of use of the multipurpose tool.

For example, a multipurpose hand held tool is disclosed that may include a handle having an outer surface and an inletted recess defined in the outer surface. The multipurpose tool also may include a retention clip mounted on the outer surface of the handle such that a portion of the retention clip extends over the inletted recess. The multipurpose tool further may include an accessory tool detachably received within the inletted recess and releaseably retained by the retention clip. In this manner, the inletted recess and the retention clip incorporate the accessory tool into the multipurpose tool, while allowing for quick removal of the accessory tool for subsequent use apart form the multipurpose tool.

In another example, a multipurpose hand held tool is disclosed that may include a handle and a rotatable tool connected to the handle. The rotatable tool may include a base, an arm, and at least one cutout positioned about an axis of the base. The multipurpose tool also may include a pivotable catch having a locking tab for releaseably engaging the at least one cutout of the rotatable tool. The multipurpose tool further may include a leaf spring biasing the locking tab toward the base of the rotatable tool. In certain embodiments, the rotatable tool may include a plurality of cutouts circumferentially spaced about the axis of the base. In this manner, the plurality of cutouts and the locking tab allow the rotatable tool to be locked at different angles relative to the handle of the multipurpose tool.

In an additional example, a multipurpose hand held tool is disclosed that may include a handle plate having an inner surface, an outer surface, and a cutout extending from the inner surface to the outer surface. The multipurpose tool also may include a rotatable tool connected to the handle plate. The rotatable tool may include a base and an arm, and a portion of the arm may be received within the cutout of the handle plate when the rotatable tool is in a storage position. In this manner, the cutout of the handle plate accommodates a rotatable tool having a large arm while minimizing overall dimensions of the handle of the multipurpose tool.

In another example, a multipurpose hand held tool is disclosed that may include a handle and a compact spanner wrench rotatably connected to the handle. The compact spanner wrench may be able to engage and rotate a castle nut. The compact spanner wrench may include a base and a head, and the head may be able to contact and extend around a circumferential surface of the castle nut. In certain embodiments, the head may include one or more engagement tabs for engaging notches of the castle nut. In this manner, the one or more engagement tabs of the head allow the compact spanner wrench to engage and rotate the castle nut in a clockwise or counter-clockwise direction.

In yet another example, a multipurpose hand held tool is disclosed that may include a first handle, a second handle, and a knife assembly detachably coupled to the first handle. The first handle may be rotatably coupled to a first plier head at a first hinge, and the second handle may be rotatably coupled to a second plier head at a second hinge. The first plier head and the second plier head may be rotatably coupled at a third hinge. The knife assembly may include a knife blade rotatably coupled to a knife handle. In certain embodiments, the knife assembly may further include a protrusion extending from a surface of the knife and a hole defined in the surface of the knife handle. In such embodiments, the first handle may include a slot defined in a surface of the first handle and a post extending from the surface of the first handle. The protrusion of the knife assembly may be detachably received within the slot of the first handle, and the hole of the knife assembly may detachably receive the post of the first handle. In this manner, the protrusion and hole of the knife assembly and the slot and post of the first handle incorporate the knife assembly into the multipurpose tool, while allowing for quick removal of the knife assembly for subsequent use apart from the multipurpose tool.

In still another example, a multipurpose hand held tool is disclosed that may include a first handle and a second handle, and the first handle may include a ratcheting bit driver. The first handle may be rotatably coupled to a first plier head at a first hinge, and the second handle may be rotatably coupled to a second plier head at a second hinge. The first plier head and the second plier head may be rotatably coupled at a third hinge. In certain embodiments, the first hinge may be positioned at a first end of the first handle, and the ratcheting bit driver may be positioned at a second end of the first handle. In certain embodiments, the ratcheting bit driver may include a first socket accessible from a first side of the first handle and a second socket accessible from a second side of the first handle. In such embodiments, the first socket may be able to rotate a bit in a clockwise direction, and the second socket may be able to rotate a bit in a counter-clockwise direction. In this manner, the ratcheting bit driver is incorporated into the first handle of the multipurpose tool in a compact configuration that allows for quick tightening or loosening of a fastener via a mating bit.

In another example, a multipurpose hand held tool is disclosed that may include a first handle, a second handle, a first multi-layered plier head, and a second multi-layered plier head. The first handle may be rotatably coupled to the first plier head at a first hinge, and the second handle may be rotatably coupled to the second plier head at a second hinge. The first plier head and the second plier head may be rotatably coupled at a third hinge. The first plier head may include a first layer having a plurality of teeth and a second layer having a cutting tool. The second plier head may include a first layer having a cutting tool and a second layer having a plurality of teeth. In this manner, the configuration of the multi-layered plier heads incorporate a plurality of teeth and a cutting tool without requiring overly complex machining of the plier heads.

In yet another example, a multipurpose hand held tool is disclosed that may include a first handle, a second handle, and a hybrid bearing system. The first handle may be rotatably coupled to a first plier head at a first hinge, and the second handle may be rotatably coupled to a second plier head at a second hinge. The first plier head and the second plier head may be rotatably coupled at a third hinge. The hybrid bearing system may be positioned about the third hinge, and the hybrid bearing system may include one or more self-lubricating washers. In certain embodiments, the hybrid bearing system may include a self-lubricating washer positioned between the first plier head and the second plier head. In this manner, the hybrid bearing system provides ongoing lubrication of the third hinge to maintain the integrity and action of the plier heads.

In still another example, a multipurpose hand held tool is disclosed that may include a first handle, a second handle, and a flashlight detachably coupled to the first handle. The first handle may be rotatably coupled to a first plier head at a first hinge, and the second handle may be rotatably coupled to a second plier head at a second hinge. The first plier head and the second plier head may be rotatably coupled at a third hinge. The multipurpose tool may further include a coupling mechanism for detachably coupling the flashlight to the first handle. In certain embodiments, the coupling mechanism may include a carrier, and a portion of the flashlight may be removably received within the carrier by a snap fit. The flashlight may include one or more grooves, and the carrier may include one or more ribs removably received within the one or more grooves of the flashlight. In this manner, the coupling mechanism may incorporate the flashlight into the multipurpose tool, while allowing for quick removal of the flashlight for subsequent use apart from the multipurpose tool. In certain embodiments, the flashlight may include an activation button, and the first handle may include an activation protrusion. The carrier may be slideably connected to the first handle such that the activation button of the flashlight may be slid into contact with the activation protrusion to activate or deactivate the flashlight. In this manner, the coupling mechanism may allow the flashlight to be used while connected to the multipurpose tool.

These and other examples will be described in more detail through reference to the accompanying drawings in the following description. It is understood, however, that the multipurpose hand held tools are not limited to the details of construction and the arrangements of the components set forth in the detailed description or shown in the accompanying drawings. The multipurpose tools are capable of other embodiments and being produced in various alternative ways. Other embodiments, aspects, and features of the multipurpose tools will become apparent to those skilled in the art from the detailed description, the accompanying drawings, and the appended claims.

### ILLUSTRATIVE EMBODIMENTS

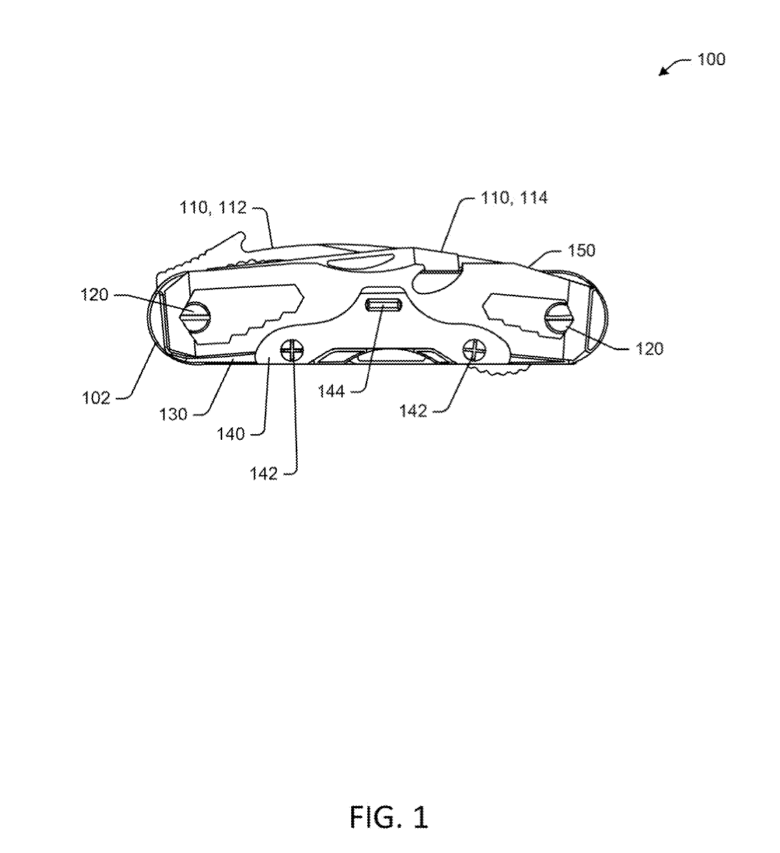

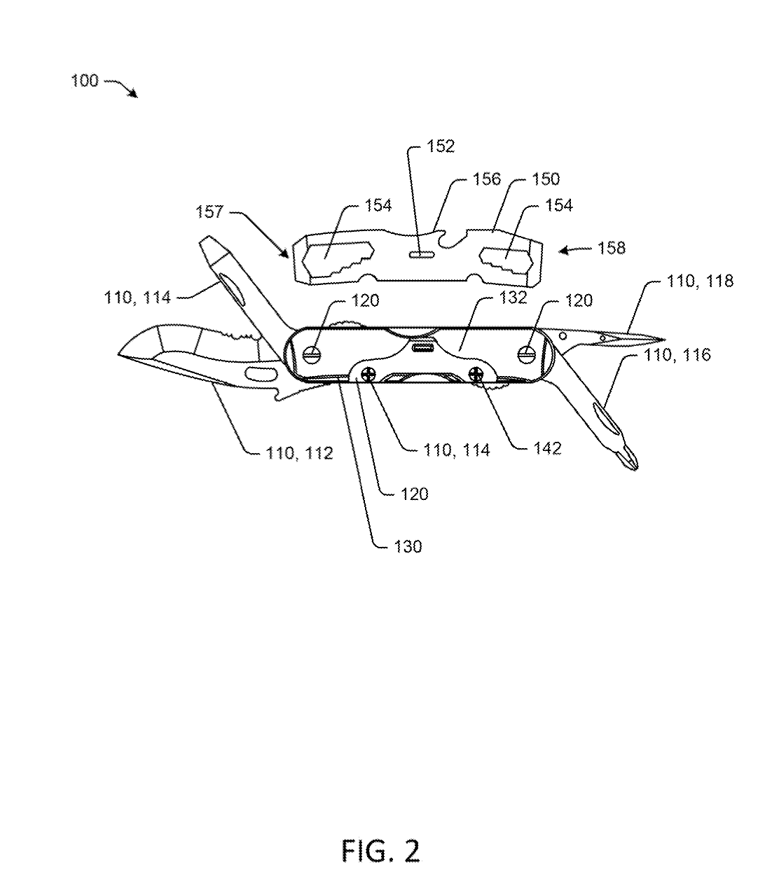

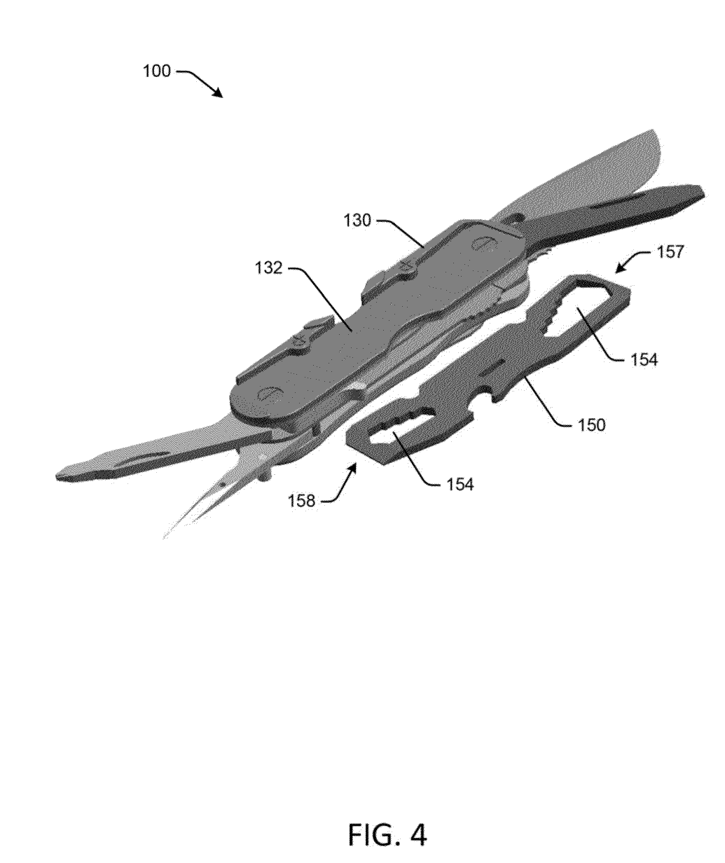

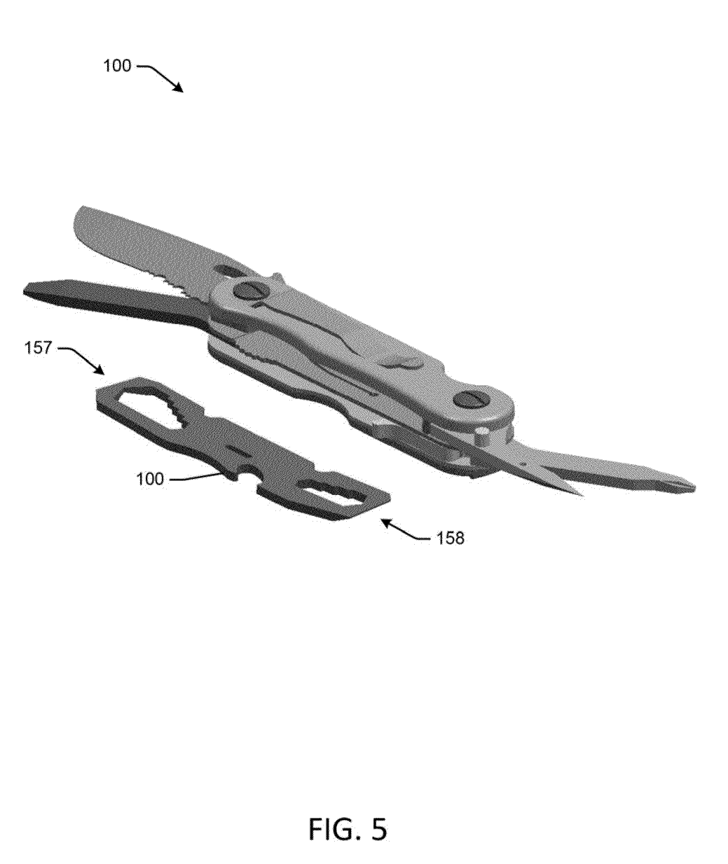

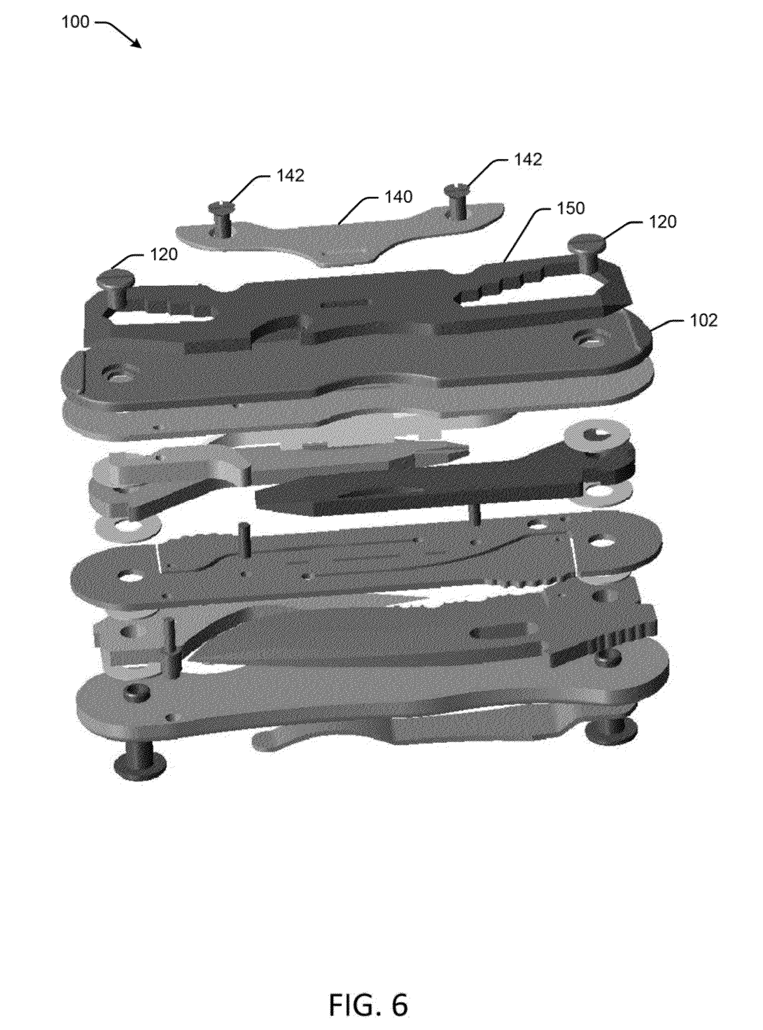

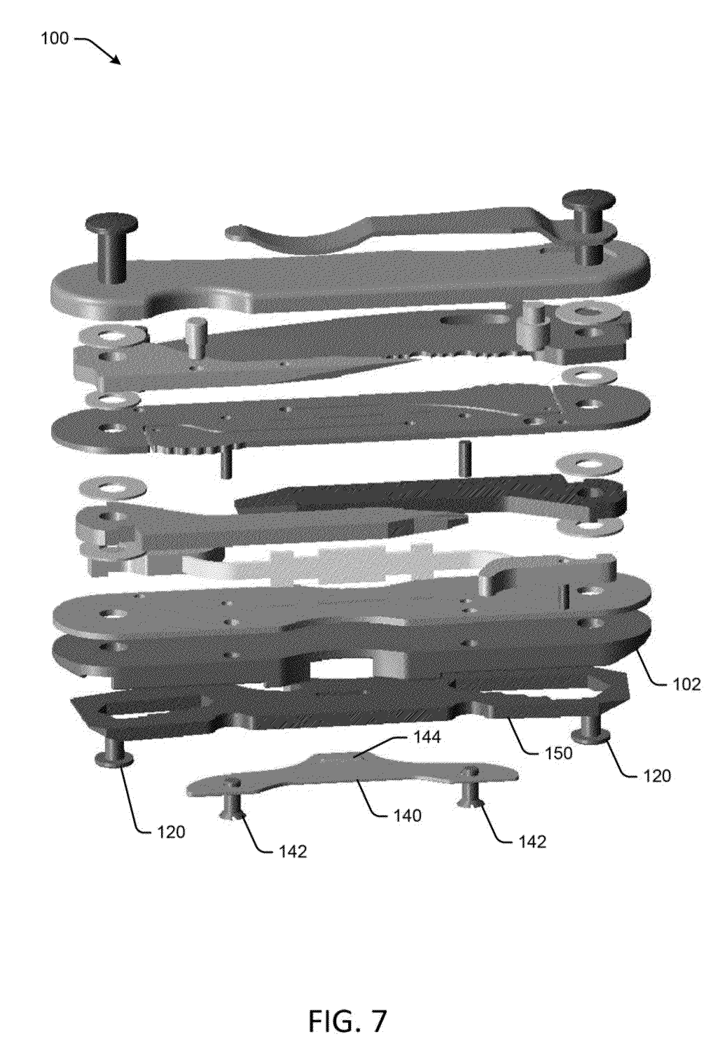

FIGS. 1-7 depict various views of a multipurpose hand held tool 100 in accordance with an embodiment of the disclosure. Specifically, FIG. 1 depicts a front view of the multipurpose tool 100 with component tools shown in a storage position, FIG. 2 depicts a front view of the multipurpose tool 100 with component tools shown in a deployed position, FIG. 3 depicts a perspective view of the multipurpose tool 100 with component tools shown in a storage position, FIG. 4 depicts a perspective view of the multipurpose tool 100 with component tools shown in a deployed position, FIG. 5 depicts a perspective view of the multipurpose tool 100 with component tools shown in a deployed position, FIG. 6 depicts a perspective exploded view of the multipurpose tool 100, and FIG. 7 depicts a perspective exploded view of the multipurpose tool 100. Collectively referring to FIGS. 1-7, and by way of example, the multipurpose tool 100 may include a handle 102 and component tools 110 connected to the handle. The component tools 110 may include various hand tools such as, but not limited to, a knife blade 112, a slotted screwdriver 114, a Phillips screwdriver 116, and an awl 118. In some examples, the component tools 110 may be rotatably connected to the handle 102 by one or more fasteners 120. Accordingly, the component tools 110 may be rotated from a storage position, as shown in FIG. 1, to a deployed position, as shown in FIG. 2.

In some examples, the handle 102 of the multipurpose tool 100 may include an outer surface 130 and an inletted recess 132 defined in the outer surface. The multipurpose tool 100 also may include a retention clip 140 mounted on the outer surface 130 of the handle 102. In some instances, the retention clip 140 may be mounted on the outer surface 130 by one or more fasteners 142. Alternatively, the retention clip 140 may be welded to the outer surface 130. The retention clip 140 may be positioned such that a portion of the retention clip 140 extends over the inletted recess 132. In some instances, the retention clip 140 may be cantilevered over the inletted recess 132. The multipurpose tool 100 further may include an accessory tool 150 detachably received within the inletted recess 132 and releaseably retained by the retention clip 140. In this manner, the inletted recess 132 and the retention clip 140 incorporate the accessory tool 150 into the multipurpose tool 100, while allowing for quick removal of the accessory tool 150 for subsequent use. Accordingly, the accessory tool 150 may be retained by the multipurpose tool 100 in a storage position, as shown in FIG. 1, or separated from the multipurpose tool 100 in a detached position, as shown in FIG. 2.

In certain examples, the retention clip 140 may include a protrusion 144 extending inwardly toward the inletted recess 132, and the accessory tool 150 may include a retention aperture 152. The protrusion 144 of the retention clip 140 may be detachably received within the retention aperture 152 of the accessory tool 150 when the accessory tool 150 is in the storage position, as shown in FIG. 1. In this manner, the protrusion 144 and the retention aperture 152 provide a mechanism for securely retaining the accessory tool 150 in the storage position.

In some examples, the accessory tool 150 may include one or more multi-hex apertures 154 having a polygonal shape that is able to engage and drive male hexagonal features of multiple sizes. In certain aspects, the accessory tool 150 may include one multi-hex aperture 154 sized to engage and drive metric-sized hexagonal features, and another multi-hex aperture 154 sized to engage and drive British-sized hexagonal features. The accessory tool 150 also may include a bottle opener 156. In some aspects, ends 157, 158 of the accessory tool 150 may be angled inwardly for ease of insertion of the accessory tool 150 into the inletted recess 132. The ends 157, 158 also may be tapered for use as a screwdriver or prybar.

In certain examples, when the accessory tool 150 is in the storage position, a portion of the accessory tool 150 may extend beyond the handle 102 for ease of grasping the accessory tool 150 for removal from the inletted recess 132. Alternatively, in other examples, when the accessory tool 150 is in the storage position, the accessory tool 150 may be received entirely within the inletted recess 132 to prevent snagging of the accessory tool 150 on objects that may come in contact with the multipurpose tool 100. In certain aspects, a surface of the accessory tool 150 may be flush with the outer surface 130 of the handle 102 to prevent snagging of the accessory tool 150 or the handle 102 on objects that may come in contact with the multipurpose tool.

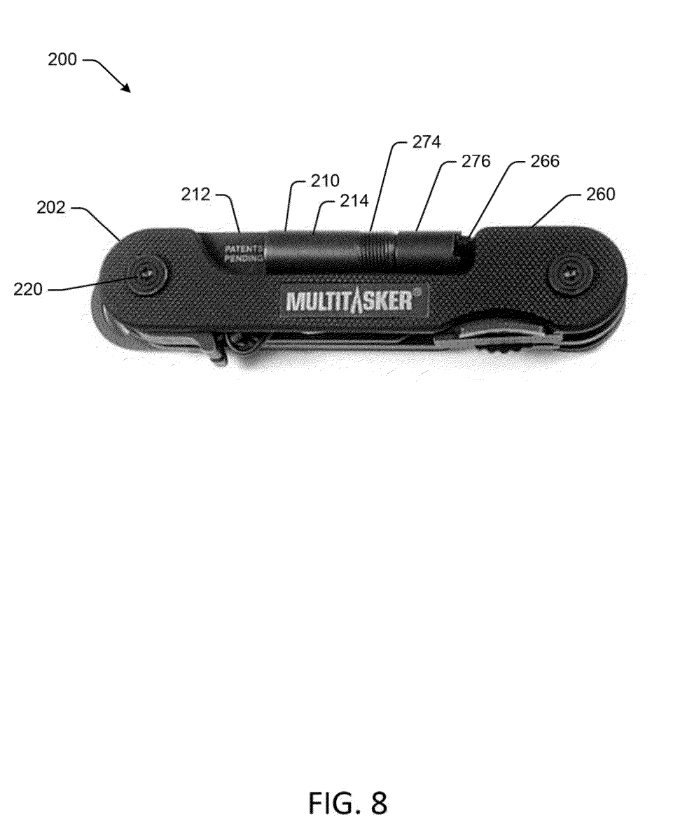

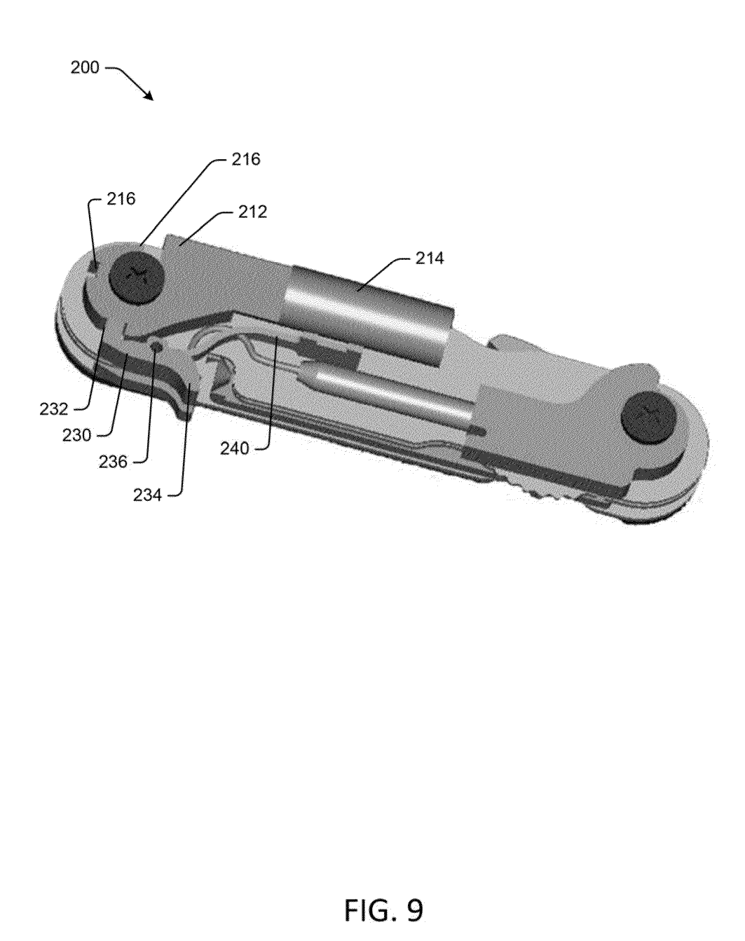

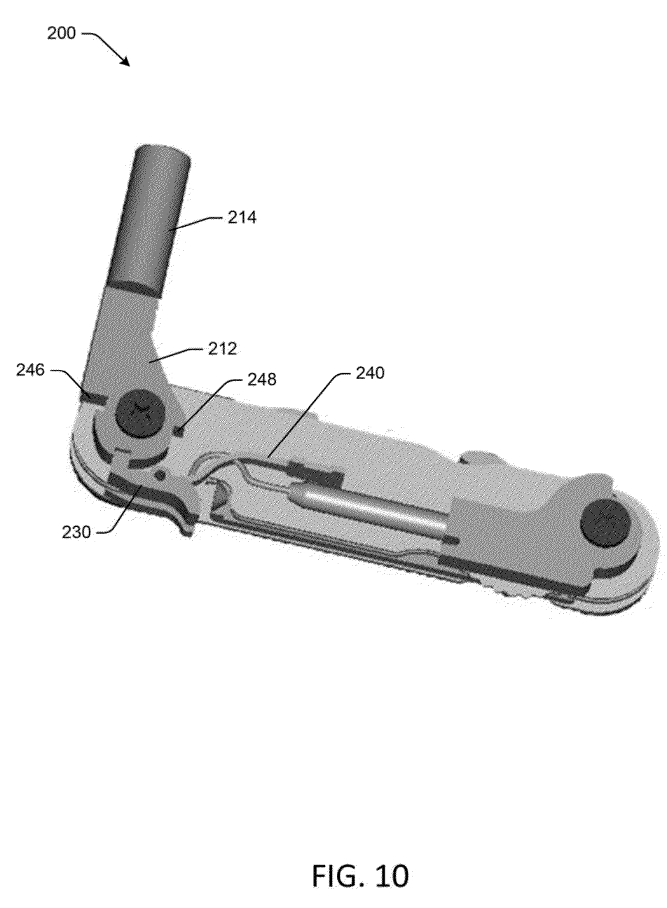

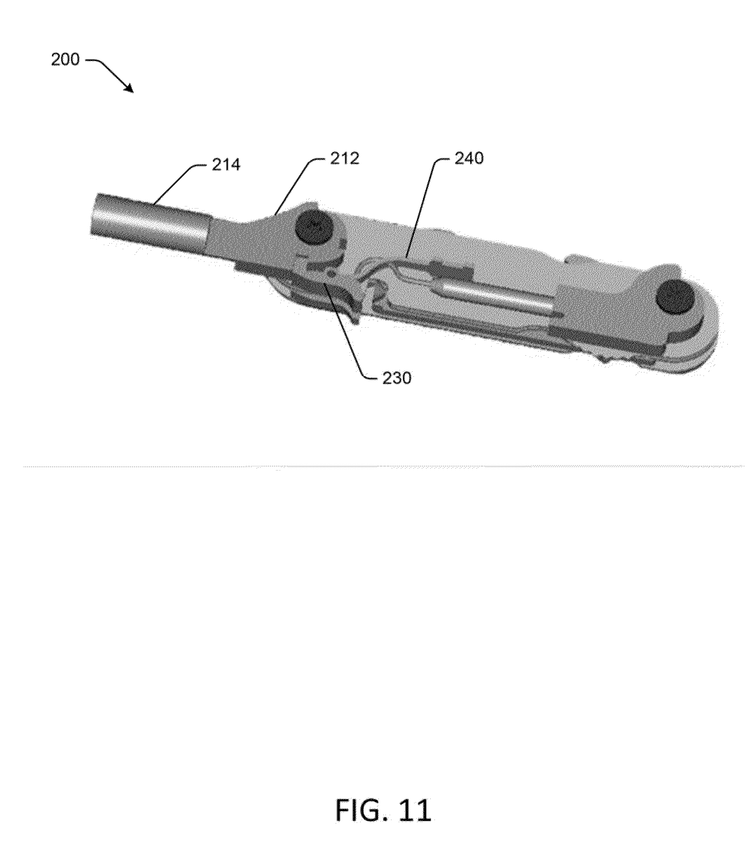

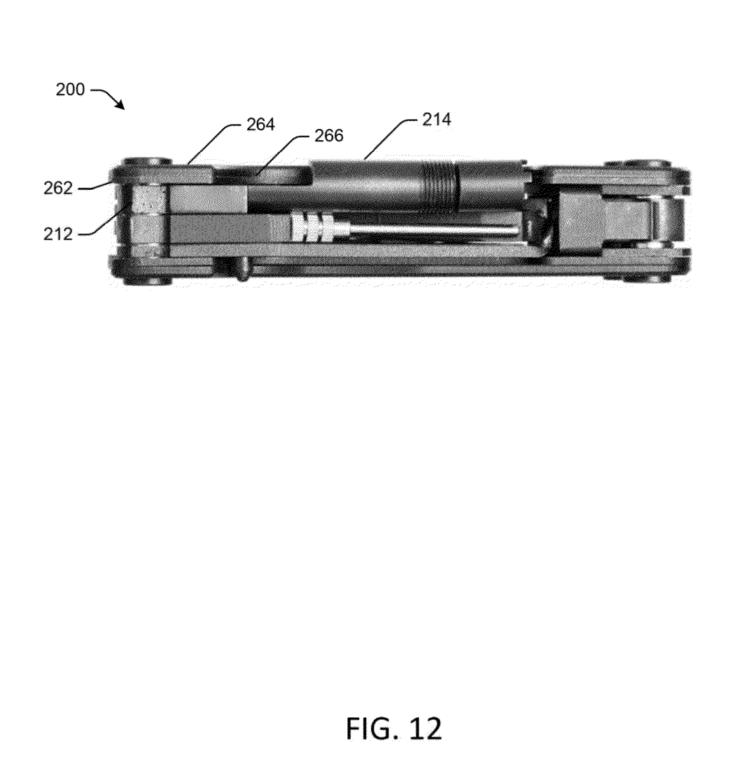

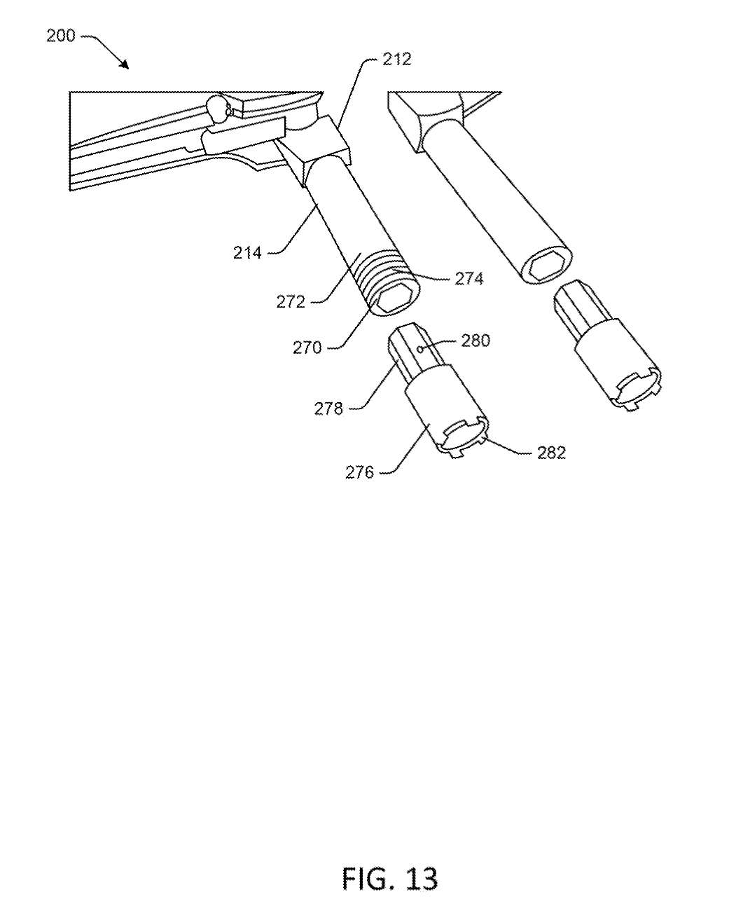

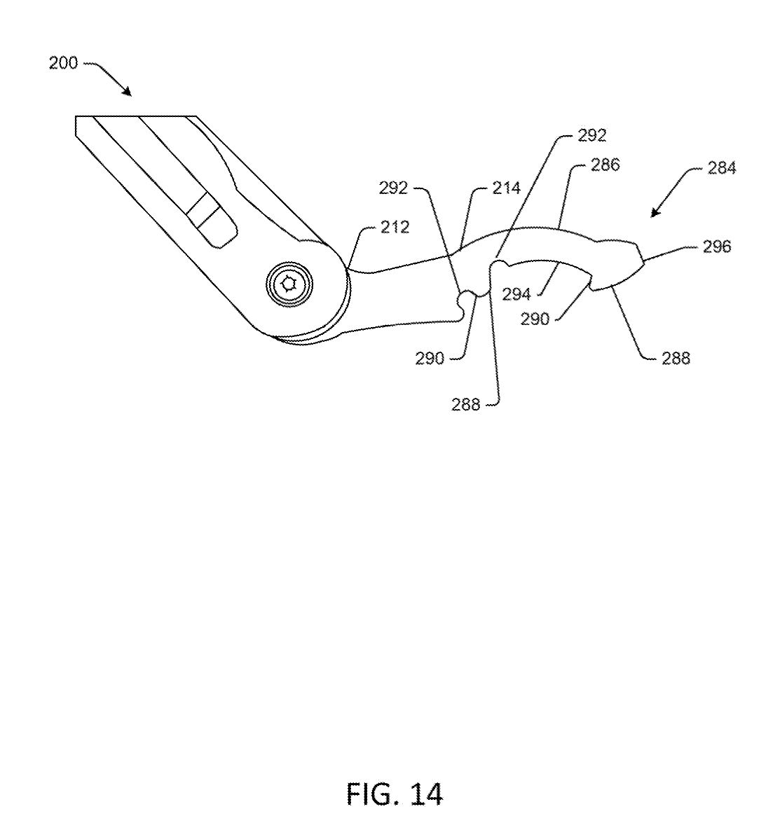

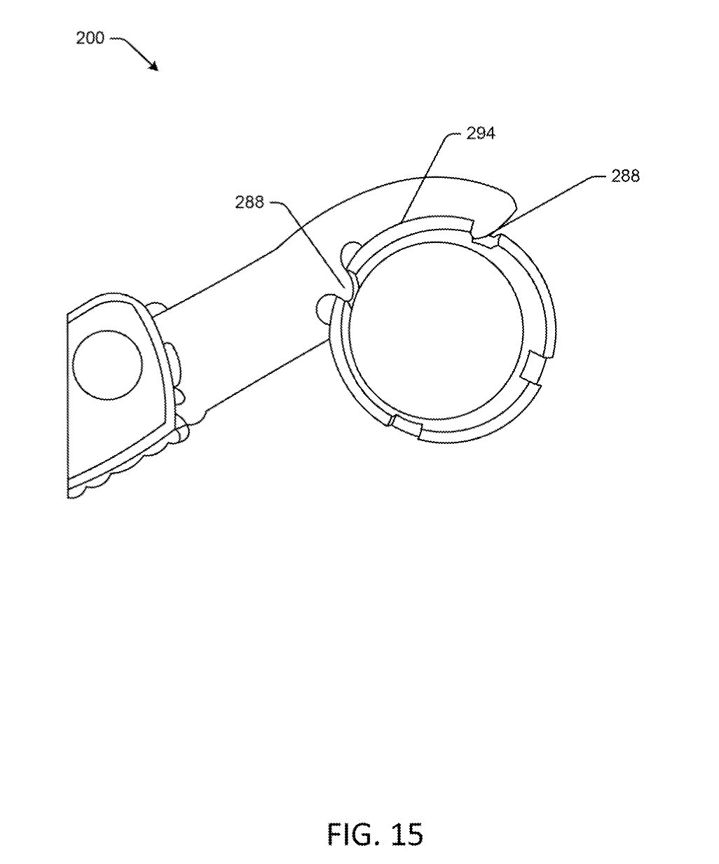

FIGS. 8-15 depict various views of a multipurpose hand held tool 200 in accordance with an embodiment of the disclosure. Specifically, FIG. 8 depicts a front view of the multipurpose tool 200 with component tools in a storage position, FIG. 9 depicts a perspective view of a locking mechanism of the multipurpose tool 200 with component tools in a storage position, FIG. 10 depicts a perspective view of the locking mechanism of the multipurpose tool 200 with a component tool in a first deployed position, FIG. 11 depicts a perspective view of the locking mechanism of the multipurpose tool 200 with the component tool in a second deployed position, and FIG. 12 depicts a top view of the multipurpose tool 200 with the component tool in the storage position, FIG. 13 depicts a perspective view of a component tool in a deployed position, FIG. 14 depicts a top view of a component tool in a deployed position, and FIG. 15 depicts a top view of the component tool in the deployed position and engaging a castle nut. Collectively referring to FIGS. 8-15, and by way of example, the multipurpose tool 200 may include a handle 202 and a rotatable tool 210 connected to the handle. The rotatable tool 210 may be rotatably connected to the handle 202 by one or more fasteners 220. Accordingly, the rotatable tool 210 may be rotated from a storage position, as shown in FIG. 8, to one or more deployed positions, as shown in FIG. 10.

In some examples, the rotatable tool 210 may include a base 212, an arm 214, and at least one cutout 216 positioned about an axis of the base 212. The multipurpose tool 200 also may include a pivotable catch 230 having a locking tab 232 for releaseably engaging the at least one cutout 216 of the rotatable tool 210. The locking tab 232 may be substantially rectangular in shape, and the at least one cutout 216 may be substantially U-shaped for securely receiving the locking tab 232. The pivotable catch 230 also may include a release lever 234 for pivoting the locking tab 232 away from the base 212 of the rotatable tool 210. The pivotable catch 230 further may include a pivot hole 236 positioned between the release lever 234 and the locking tab 232. In certain aspects, the pivotable catch 230 may be connected to the handle 202 by a pin 238 received through the pivot hole 236. The multipurpose tool 200 further may include a leaf spring 240 biasing the locking tab 232 toward the base 212 of the rotatable tool 210. The leaf spring 240 may directly contact the release lever 234 such that the locking tab 232 is biased toward the base 212 of the rotatable tool 210. In this manner, the locking tab 232 contacts the base 212 of the rotatable tool 210 unless the release lever 234 is depressed to pivot the locking tab 232 away from the base 212. In some aspects, the release lever 234 may extend beyond the handle 202 of the multipurpose tool 200 for ease of access of the release lever 234.

In certain examples, the rotatable tool 210 may include a plurality of cutouts 216 circumferentially spaced about the axis of the base 212. In this manner, the plurality of cutouts 216 and the locking tab 232 allow the rotatable tool 210 to be locked at different angles relative to the handle of the multipurpose tool. In some aspects, one of the plurality of cutouts 216 may be located such that the arm 214 of the rotatable tool 210 may be locked at a 90-degree angle relative to the handle 202 of the multipurpose tool 200. In other aspects, one of the plurality of cutouts 216 may be located such that the arm 214 of the rotatable tool 210 may be locked at a 180-degree angle relative to the handle 202 of the multipurpose tool 200. One will appreciate, however, that the plurality of cutouts 216 may be located such that the arm 214 of the rotatable tool 210 may be locked at any angle relative to the handle 202 of the multipurpose tool 200. In certain aspects, the rotatable tool 210 further may include a first stop 246 and a second stop 248 positioned about the axis of the base 212. The first stop 246 may be located to prevent rotation of the rotatable tool 210 in a first direction of rotation, and the second stop 248 may be located to prevent rotation of the rotatable tool 210 in a second direction of rotation. In some aspects, the first stop 246 and the second stop 248 may be configured to contact the locking tab 232 in order to prevent rotation of the rotatable tool 210. Additionally, the first stop 246 and the second stop 248 may be configured to contact the locking tab 232 and prevent rotation of the rotatable tool 210 whether the release lever 234 is depressed or not. In certain instances, each of the first stop 246 and the second stop 248 may be positioned about the base 212 of the rotatable tool 210 and adjacent one of the plurality of cutouts 216.

In some examples, the handle 202 of the multipurpose tool 200 may include a handle plate 260 having an inner surface 262, an outer surface 264, and a cutout 266 extending from the inner surface 262 to the outer surface 264. As shown in FIGS. 8 and 12, when the rotatable tool 210 is in the storage position, a portion of the arm 214 of the rotatable tool 210 may be received within the cutout 266 of the handle plate 260. In this manner, the cutout 266 of the handle plate 260 accommodates the rotatable tool 210 having a large arm 214 while minimizing overall dimensions of the handle 202 of the multipurpose tool 200. In certain aspects, a portion of the arm 214 may be flush with the outer surface 264 of the handle plate 260 when the rotatable tool 210 is in the storage position. Alternatively, a portion of the arm 214 may extend through the cutout 266 and beyond the outer surface 264 of the handle plate 260 when the rotatable tool 210 is in the storage position. In certain aspects, a width of the arm 214 may be greater than a width of the base 212 of the rotatable tool 210. In some aspects, the arm 214 may be laterally offset relative to the base 212 of the rotatable tool 210. In certain aspects, a cross-section of the arm 214 may be substantially circular, and a cross-section of the base 212 may be substantially rectangular. Accordingly, the cutout 266 of the handle plate 260 may accommodate a rotatable tool 210 having a large width or an offset configuration, while minimizing the overall width of the multipurpose tool 200.

In certain examples, the rotatable tool 210 may include a hex bit driver 270 positioned at an end of the arm 214, as shown in FIG. 13. The hex bit driver 270 may be a ¼-inch driver that allows for compatibility with common hardware tool bits used for engaging and driving various types of fasteners. In some aspects, the hex bit driver 270 includes an internal magnet 272 for releaseably retaining metal tool bits. Accordingly, the hex bit driver 270 may be used in an inverted manner while retaining a mating tool bit. In certain aspects, the hex bit driver 270 may include threads 274 defined on an external surface for attachment of threaded tools or accessories. Particularly, the threads 274 may be used for attachment of tools or accessories that are used in a prying or levering manner and that would not be adequately retained by a hex connection. In some aspects, the rotatable tool 210 further may include a tool bit 276 releaseably received by the hex bit driver 270. When the rotatable tool 210 is in the storage position, a portion of the tool bit 276 may be received within the cutout 266 of the handle plate 260 of the multipurpose tool 200. The tool bit 276 may include a hex base 278 and a ball detent 280 positioned within the hex base for secure retention within the hex bit driver 270. In certain aspects, the tool bit 276 may include a working end having a plurality of posts 282 for engaging specific cutouts or recesses defined in a mating fastener or other component.

In some examples, the rotatable tool 210 may include a compact spanner wrench 284 positioned at an end of the arm 214, as shown in FIGS. 14 and 15. The compact spanner wrench 284 may be able to engage and rotate a castle nut. In certain aspects, the compact spanner wrench 284 may include a head 286 having an arc shape such that the head is able to contact and extend around a circumferential surface of the castle nut. The head 286 may be configured to extend less than 180-degrees around the circumferential surface of the castle nut. One will appreciate, however, that the head 286 may be configured to extend any number of degrees around the circumferential surface of the castle nut. Accordingly, the outer dimensions of the head 286 may be minimized such that the compact spanner wrench 284 may be incorporated into as small of a handle 202 as possible. In certain aspects, the head 286 may include one or more engagement tabs 288 for engaging notches of the castle nut. In this manner, the one or more engagement tabs 288 of the head 286 allow the compact spanner wrench to engage and rotate the castle nut in a clockwise or counter-clockwise direction. In some aspects, the head 286 may include two engagement tabs 288 for engaging two adjacent notches of the castle nut. One will appreciate, however, that the head 286 may include any number of engagement tabs 288 for engaging any number of notches, adjacent or non-adjacent, of the castle nut. In certain aspects, one of the engagement tabs 288 may have an asymmetric shape such that the engagement tab 288 contacts only one axial surface of a notch of the castle nut when the head 286 engages the castle nut. Accordingly, the engagement tabs 288 each may include a contact surface 290 for contacting an axial surface of a notch of the castle nut. In some aspects, the head 286 may include one or more relief cutouts 292 adjacent at least one of the engagement tabs 288. The head 286 also may include a support surface 294 positioned between two engagement tabs 288 such that the support surface 294 is able to contact the circumferential surface of the castle nut when the two engagement tabs 288 engage notches of the castle nut. In certain aspects, the head 286 may include a screwdriver tip 296 located at an end of the head 286.

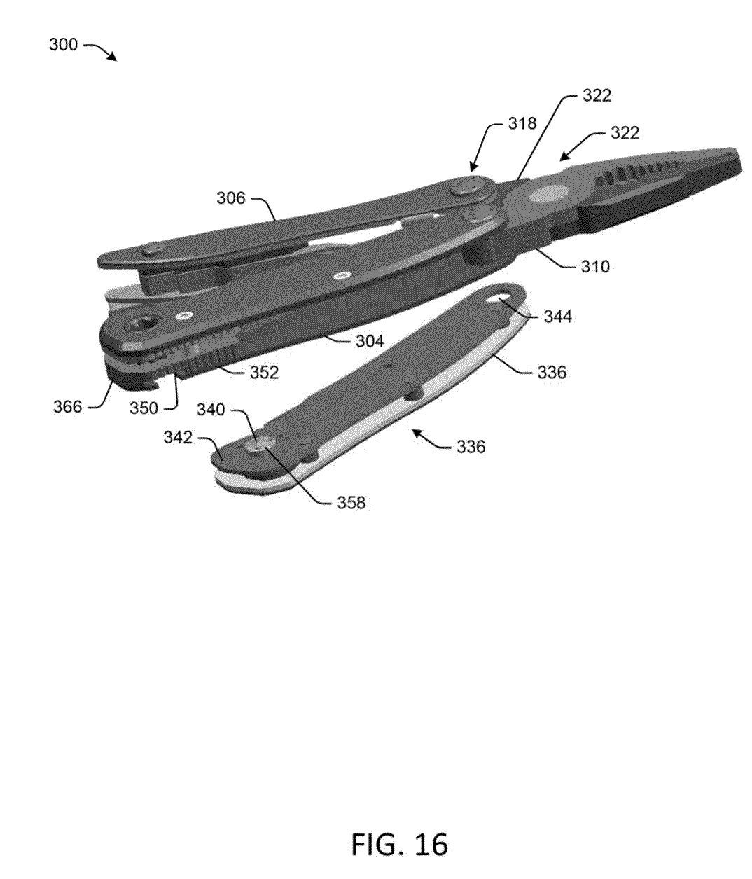

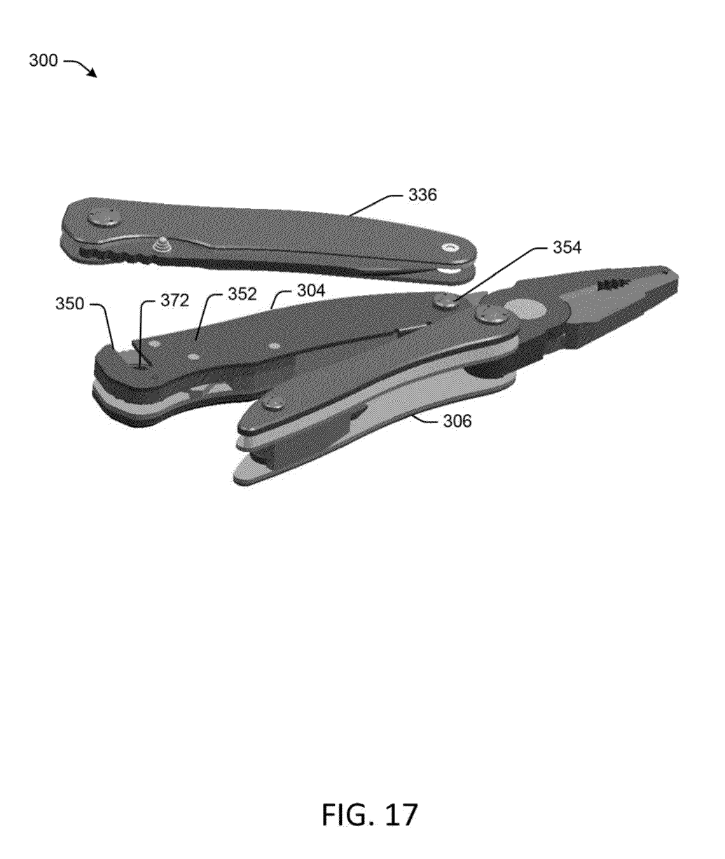

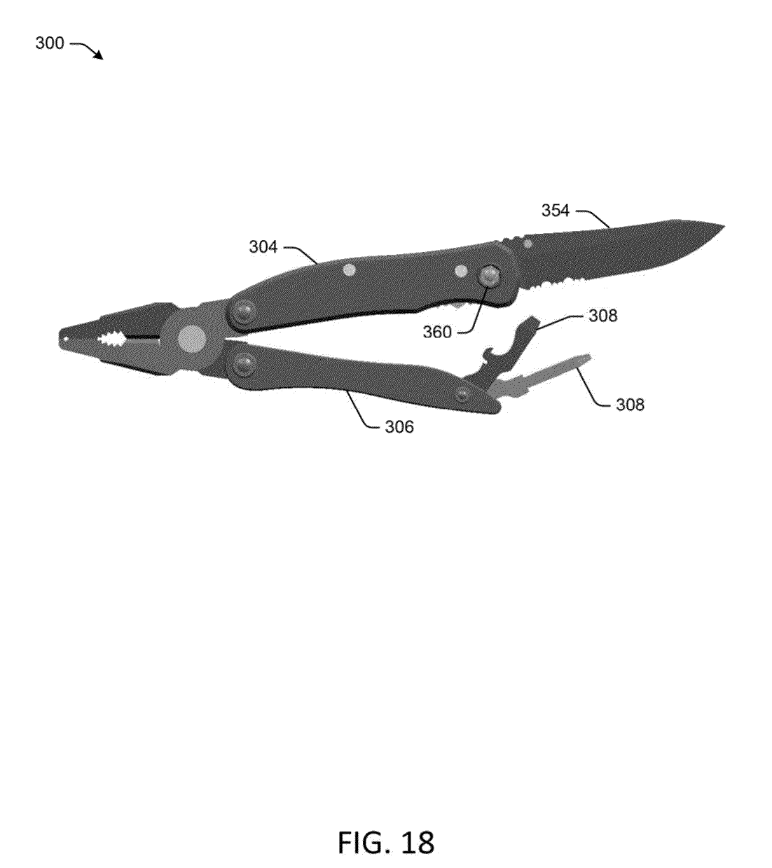

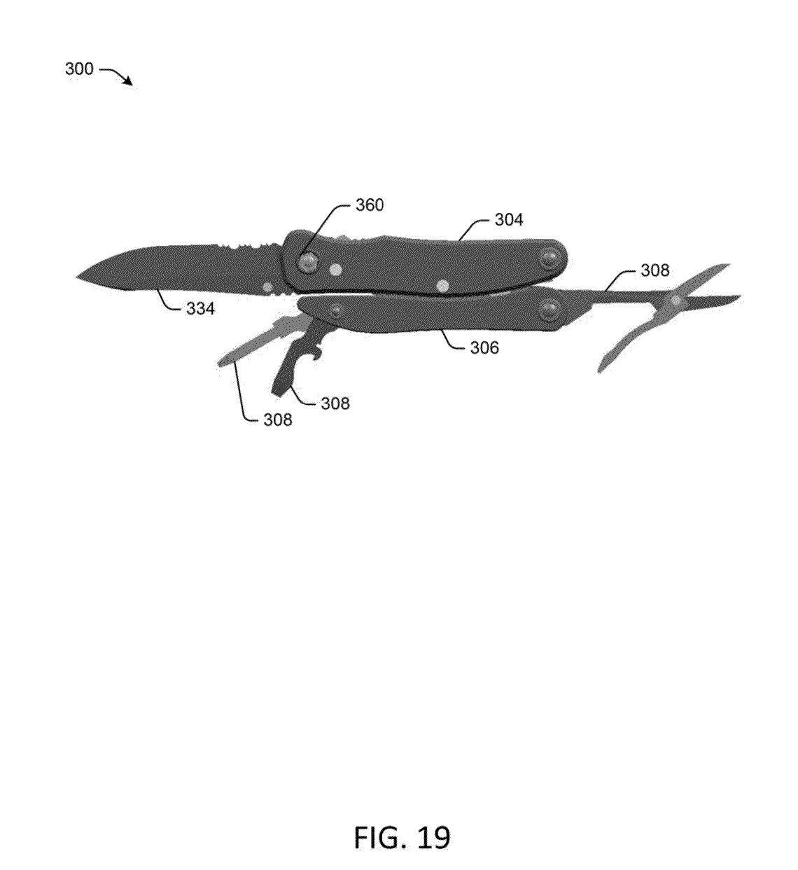

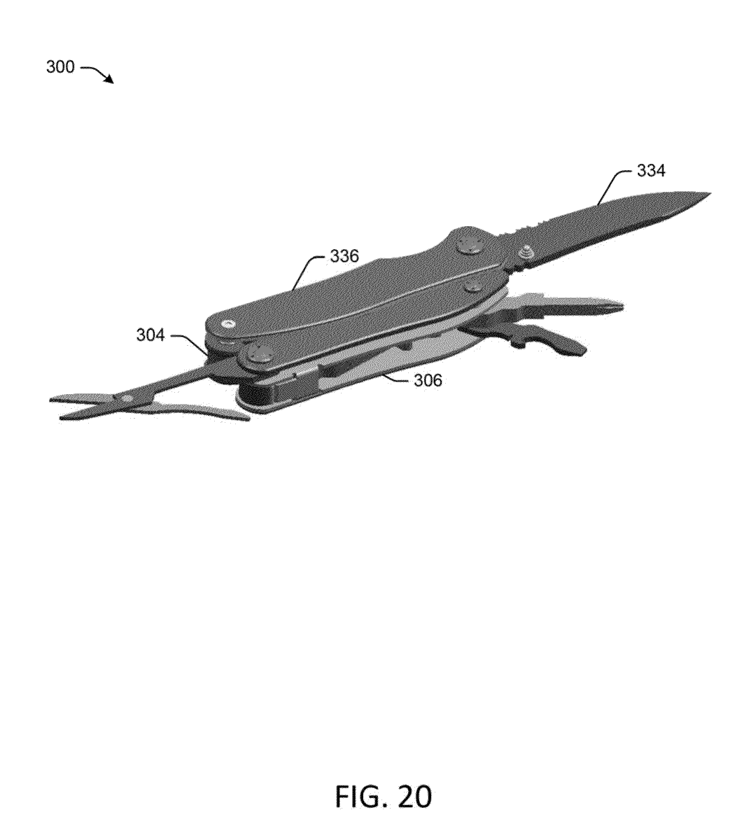

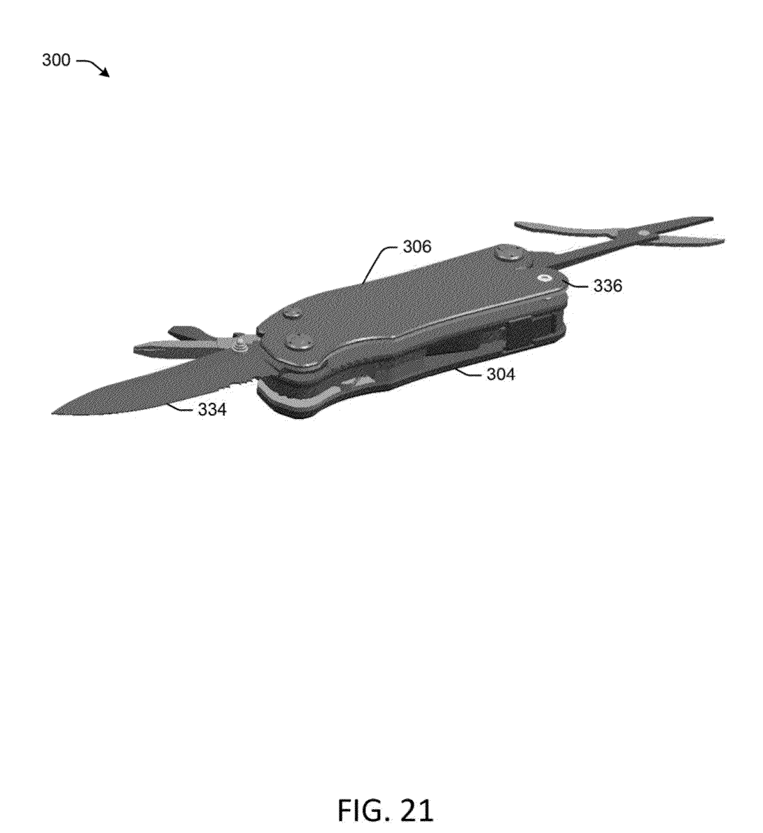

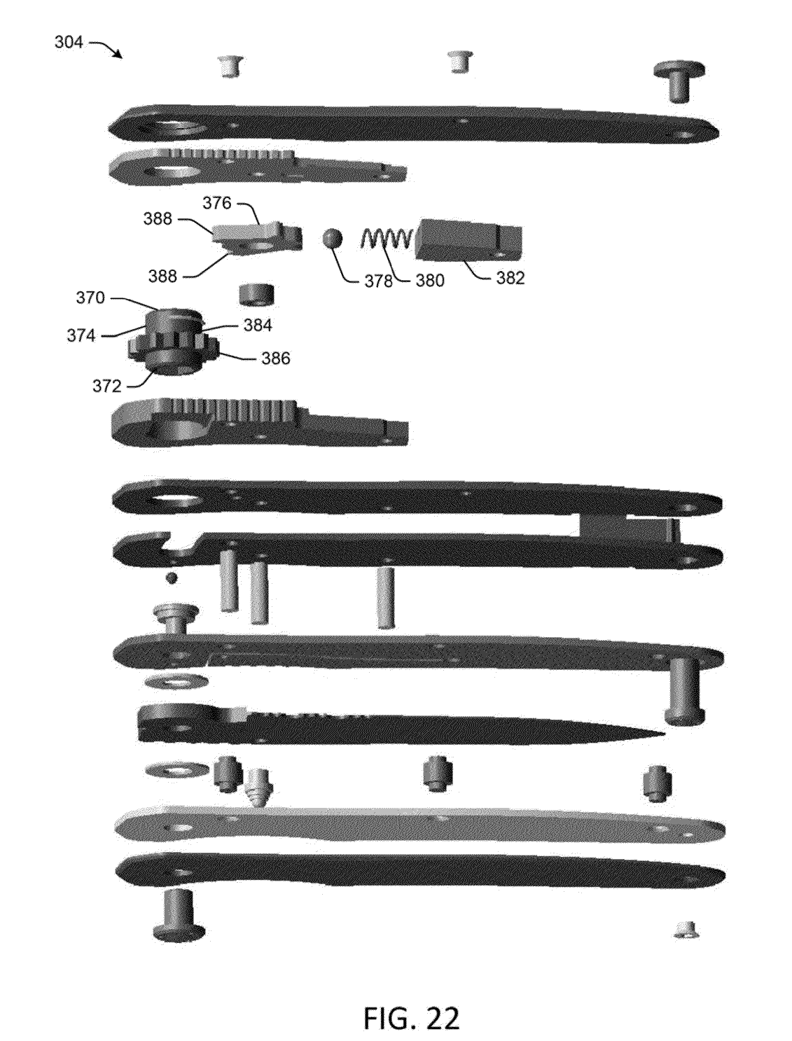

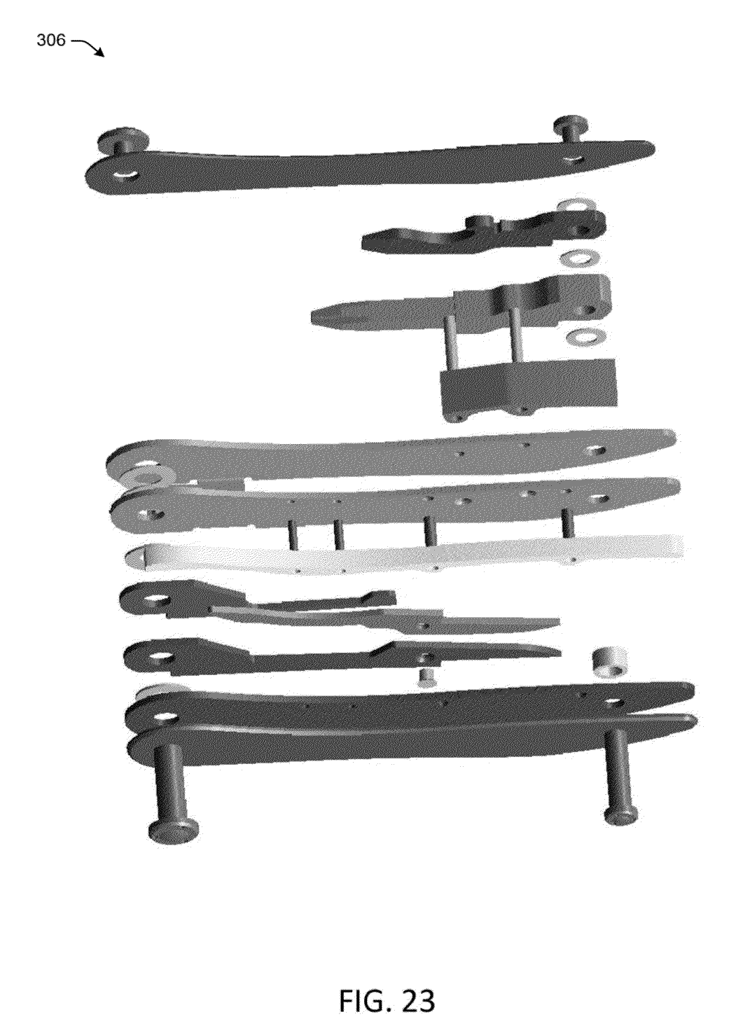

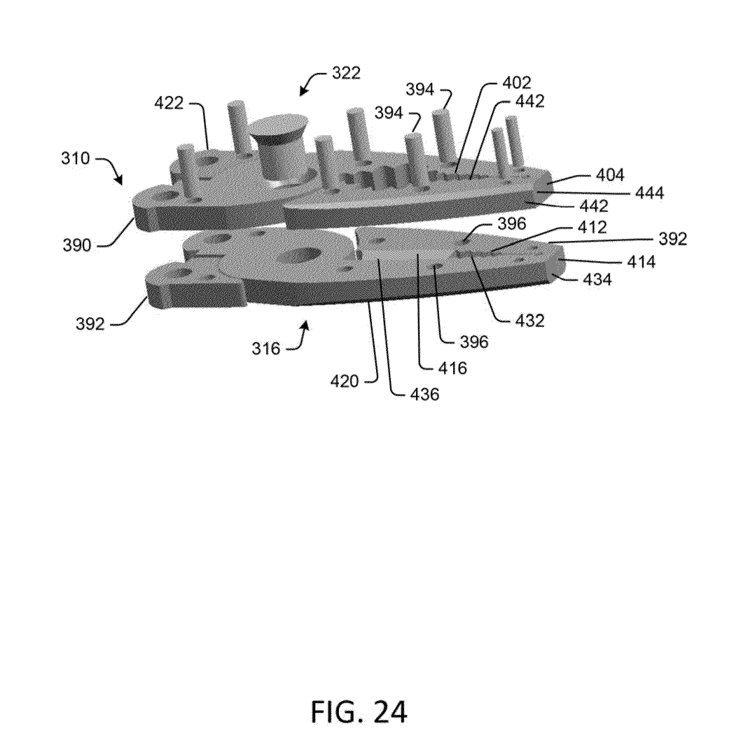

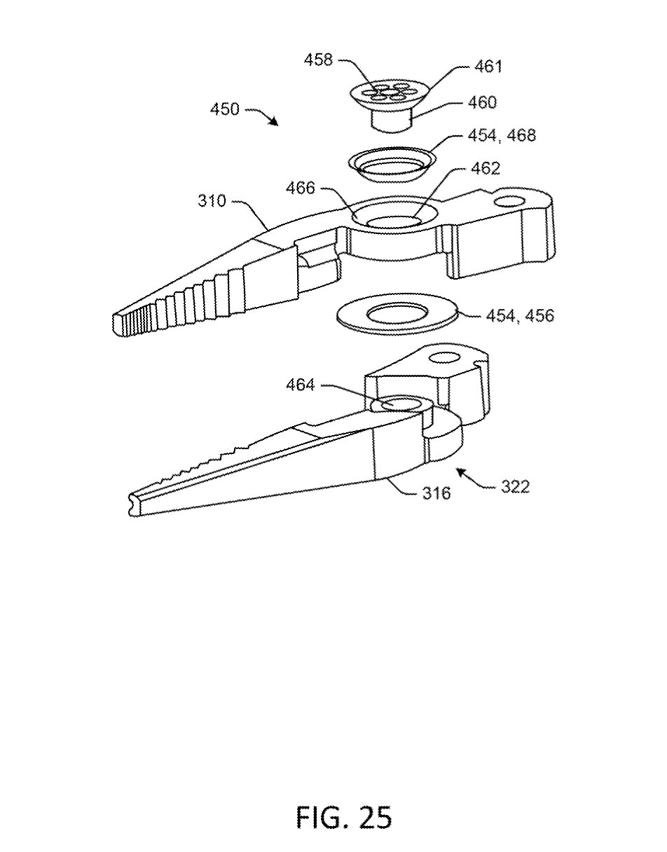

FIGS. 16-25 depict various views of a multipurpose hand held tool 300 in accordance with an embodiment of the disclosure. Specifically, FIG. 16 depicts a perspective view of the multipurpose tool 300 with a component assembly detached from the remainder of the multipurpose tool 300, FIG. 17 depicts a perspective view of the multipurpose tool 300 with the component assembly detached from the remainder of the multipurpose tool 300, FIG. 18 depicts a front view of the multipurpose tool 300 with the component assembly attached to the remainder of the multipurpose tool 300, and the component assembly is in a deployed position, FIG. 19 depicts a front view of the multipurpose tool 300 with the component assembly attached to the remainder of the multipurpose tool 300, and the component assembly is in a deployed position, FIG. 20 depicts a perspective view of the multipurpose tool 300 with the component assembly attached to the remainder of the multipurpose tool 300, and the component assembly is in a deployed position, FIG. 21 depicts a perspective view of the multipurpose tool 300 with the component assembly attached to the remainder of the multipurpose tool 300, and the component assembly is in a deployed position, FIG. 22 depicts a perspective exploded view of the component assembly and a handle of the multipurpose tool 300, FIG. 23 depicts a perspective exploded view of a handle of the multipurpose tool 300, FIG. 24 depicts a perspective exploded view of a plier head assembly of the multipurpose tool 300, and FIG. 25 depicts a perspective exploded view of a plier head assembly of the multipurpose tool 300. Collectively referring to FIGS. 16-25, and by way of example, the multipurpose tool 300 may include a first handle 304 and a second handle 306. The multipurpose tool 300 may also include component tools 308 connected to the first handle 304 or the second handle 306. In some examples, the component tools 308 may be rotatably connected to the first handle 304 or the second handle 306 by fasteners. Accordingly, the component tools 308 may be rotated from a storage position, as shown in FIG. 16, to one or more deployed positions, as shown in FIG. 18.

In some examples, the first handle 304 may be rotatably coupled to a first plier head 310 at a first hinge 312, and the second handle 306 may be rotatably coupled to a second plier head 316 at a second hinge 318. Additionally, the first plier head 310 and the second plier head 316 may be rotatably coupled at a third hinge 322. In this manner, the first plier head 310 and the second plier head 316 may rotate relative to one another about the third hinge 322 to provide traditional pliers action. Furthermore, the first handle 304 and the second handle 306 may be rotated relative to the first plier head 310 and the second plier head 316, respectively, about the first hinge 312 and the second hinge 318, respectively. In this manner, the handles 304, 306 may be rotated relative to the plier heads 310, 316 such that the plier heads 310, 316 may be in a deployed position, as shown in FIG. 16, or a storage position, as shown in FIG. 19.

In certain examples, the multipurpose tool 300 may include a knife assembly 330 detachably coupled to the first handle 304. The knife assembly 330 may include a knife blade 334 rotatably coupled to a knife handle 336. In certain aspects, the knife assembly 330 may further include a protrusion 340 extending from a surface 342 of the knife handle 336. The knife assembly 336 also may include a hole 344 defined in the surface 342 of the knife handle 336. In some embodiments, the first handle 304 may include a slot 350 defined in a surface 352 of the first handle 304. The first handle 304 also may include a post 354 extending from the surface 352 of the first handle 304. In this manner, the protrusion 340 of the knife assembly 330 may be detachably received within the slot 350 of the first handle 304, and the hole 344 of the knife assembly 330 may detachably receive the post 354 of the first handle 304. Accordingly, the protrusion 340 and hole 344 of the knife assembly 330 and the slot 350 and post 354 of the first handle 304 may incorporate the knife assembly 330 into the overall multipurpose tool 300, while allowing for quick removal of the knife assembly 330 for subsequent use apart from the multipurpose tool 300.

In certain aspects, the slot 350 of the first handle 304 may be substantially U-shaped for ease of insertion and capture of the protrusion 340 of the knife assembly 330. The slot 350 also may be tapered for ease of insertion and locking of the protrusion 340 of the knife assembly 330. In some aspects, the protrusion 340 may be received within the slot 350 by a friction fit or interference fit. The protrusion 340 may include a flange 358 having an outer diameter that is greater than a width of the slot 350. Accordingly, the flange 358 may assist in retaining the protrusion 340 within the slot 350. It is understood that certain features of the knife assembly 330 alternatively may be included on the first handle 304, and vice versa. For example, the knife assembly 330 may include a slot and a post, and the first handle 304 may include a protrusion and hole for detachably coupling the knife assembly 330 to the first handle 304. In some aspects, a profile of the knife handle 336 of the knife assembly 330 may match a corresponding profile of the first handle 304. Such configuration may allow for a multipurpose tool 300 that is more ergonomic to use when the knife assembly 330 is attached to the first handle 304. Further, the matching profiles may prevent snagging of the knife assembly 330 or the first handle 304. In certain aspects, a combined thickness of the knife assembly 330 and the first handle 304 may be equal to a thickness of the second handle 306. Such configuration further may allow for a multipurpose tool 300 that is more ergonomic to use when the knife assembly 330 is attached to the first handle 304.

In some examples, the first handle 304 may include a ratcheting bit driver 360. In certain aspects, the first hinge 312 of the multipurpose tool 300 may be positioned at one end of the first handle 304, and the ratcheting bit driver 360 may be positioned at an opposite end of the first handle 304. In some aspects, a rotational axis of the ratcheting bit driver 360 may be parallel to a rotational axis of the first hinge 312. Additionally, the ratcheting bit driver 360 may be positioned between outer plates 364, 366 of the first handle 304. The ratcheting bit driver 360 may include a first socket 370 accessible from one side of the first handle 304 and a second socket 372 accessible from an opposite side of the first handle 304. In certain aspects, the first socket 370 may be accessible through one outer plate 364, and the second socket may be accessible through another outer plate 366. The first socket 370 may be able to rotate a mating bit in a first direction, for example, a clockwise direction. The second socket 372 may be able to rotate a mating bit in a second direction, for example, a counter-clockwise direction.

In some aspects, the ratcheting bit driver 360 may include a bit holder 374, a pawl 376, a ball bearing 378, a spring 380, and a spring housing 382, as shown in FIG. 22. The bit holder 374 may include the first socket 370 defined in one end of the bit holder 374 and the second socket 372 defined in an opposite end of the bit holder 374. The bit holder 374 also may include an internal magnet 384 for retaining a mating bit in one or both of the first socket 370 and the second socket 372. The bit holder 374 further may include a plurality of axially extending teeth 386 that are able to engage the pawl 376. In certain aspects, the spring housing 382 may receive at least a portion of the spring 380 and may orient the spring 380 to apply a spring force toward the pawl 376. In some aspects, the spring 380 may contact the ball bearing 378 and may bias the ball bearing 378 into contact with the pawl 376. In other aspects, the spring 380 may directly contact the pawl 376. The pawl 376 may be biased toward contacting the teeth 386 of the bit holder 374. In certain aspects, the pawl 376 may include one or more radially-extending fingers 388 that are rotatably biased toward contacting the teeth 386 of the bit holder 374. In some aspects, the pawl 376 may be movable from a first ratcheting position, in which the pawl 376 allows the bit holder 374 to ratchet in a first direction of rotation, to a second ratcheting position, in which the pawl 376 allows the bit holder 374 to ratchet in a second direction of rotation. For example, when the pawl 376 is in the first ratcheting position, the bit holder 374 may be able to ratchet in a clockwise direction, and when the pawl 376 is in the second ratcheting position, the bit holder 374 may be able to ratchet in a counter-clockwise direction. As shown in FIGS. 16-23, the ratcheting bit driver 360 may be positioned entirely within the first handle 304 of the multipurpose tool 300. In this manner, the ratcheting bit driver 360 may be incorporated into the multipurpose tool 300 in a compact configuration that allows for easy access to tighten or loosen a fastener Via a mating tool bit.

In certain examples, as shown in FIG. 24, each of the first plier head 310 and the second plier head 316 may have a multi-layered configuration. The first plier head 310 may include a first layer 390 and a second layer 392. The first layer 390 and the second layer 392 of the first plier head 310 may be connected by fasteners 394. The fasteners 394 may be received within corresponding holes 396 defined in each of the first layer 390 and the second layer 392. In certain aspects, the fasteners 394 may be press-fit pins, rivets, or other known fasteners. The first layer 390 may include a plurality of teeth 402 positioned between the third hinge 322 and a distal tip 404 of the first layer 390. The second layer 392 may include a plurality of teeth 412 positioned between the third hinge 322 and a distal tip 414 of the second layer 392. The second layer 392 also may include a cutting tool 416 positioned between the third hinge 322 and the plurality of teeth 412 of the second layer 392. In this manner, the plurality of teeth 412 of the first layer 390 may extend over the cutting tool 416 of the second layer 392 of the first plier head 310. The second plier head 316 similarly may include a first layer 420 and a second layer 422. The first layer 420 and the second layer 422 of the second plier head 316 may be connected by fasteners 394. The fasteners 394 may be received within corresponding holes 396 defined in each of the first layer 420 and the second layer 422. The first layer 420 may include a plurality of teeth 432 positioned between the third hinge 322 and a distal tip 434 of the first layer 390. The first layer 420 also may include a cutting tool 436 positioned between the third hinge 322 and the plurality of teeth 432 of the first layer 420. The second layer 422 may include a plurality of teeth 442 positioned between the third hinge 322 and a distal tip 444 of the second layer 422. In this manner, the plurality of teeth 442 of the second layer 422 may extend over the cutting tool 436 of the first layer 420 of the second plier head 316. Accordingly, each of the first plier head 310 and the second plier head 316 may incorporate a plurality of teeth and a cutting tool without requiring overly complex machining of the plier heads.

In some aspects, one or more of the plurality of teeth 402, 412, 432, 442 may have a graduated configuration. In other words, the teeth 402, 412, 432, 442 may be smaller towards the distal tip 404, 414, 434, 444, respectively, and gradually increase in size towards the third hinge 322. In other aspects, one or more of the plurality of teeth 402, 412, 432, 444 may vary in size according to a stepped configuration. That is, the teeth 402, 412, 432, 442 may include groupings of teeth that are the same size, and the size of the teeth in each grouping may increase from the distal tip 404, 414, 434, 444 towards the third hinge 322. In is understood that the graduated configuration or stepped configuration of the teeth may be incorporated into one or both of the first plier head 310 and the second plier head 316 whether the plier heads 310, 316 have a multi-layered configuration or a single layer configuration. By providing the teeth 402, 412, 432, 442 in a graduated configuration or stepped configuration, the plier heads 310, 316 may be able to grasp objects of many different sizes and shapes.

In some examples, as shown in FIG. 25, the first plier head 310 and the second plier head 316 may be rotatably coupled at the third hinge 322 by a hybrid bearing system 450. The hybrid bearing system 450 may include one or more self-lubricating washers 454 positioned about the third hinge 322. The self-lubricating washers 454 may be made of one or more metals or polymer materials impregnated with a lubricant. When positioned between bearing surfaces of the first plier head 310 and the second plier head 316, friction generated by rotation of the plier heads 310, 316 relative to one another may cause the self-lubricating washers 454 to release the lubricant onto the bearing surfaces. In certain aspects, the hybrid bearing system 450 may include a first self-lubricating washer 456 positioned about the third hinge 322 and pressed between the first plier head 310 and the second plier head 316. In this manner, the first lubricating washer 456 may lubricate the bearing surfaces of the plier heads 310, 316 to maintain the integrity and action of the plier heads 310, 316 about the third hinge 322.

In some aspects, the plier heads 310, 316 may be connected by a fastener 458 including a post 460 and a flanged head 461. The post 460 may extend through a hole 462 defined in the first plier head 310 and may be received within a hole 464 defined in the second plier head 316. In certain instances, the fastener 458 may be a press-fit pill, and the post 460 may be press fit into the hole 464 of the second plier head 316. In other aspects, the fastener 458 may be a threaded fastener, and the post 460 may be threaded into the hole 464 of the second plier head 316. In still other aspects, the fastener 458 may be a rivet, and the post 460 may be deformed within the hole 464 of the second plier head 316. The flanged head 461 of the fastener 458 may be frusto-conical, and the flanged head 461 may be received within a countersink 466 of the hole 462 of the first plier head 310. In some aspects, the hybrid bearing system 450 may include a second self-lubricating washer 468 positioned about the third hinge 322 and pressed between the flanged head 461 of the fastener 458 and the first plier head 310. The second self-lubricating washer 468 may have a frusto-conical shape and may be received within the countersink 466 of the hole 462 of the first plier head 310. In this manner, the second self-lubricating washer 468 may lubricate the bearing surfaces of the fastener 458 and the first plier head 310 to maintain the integrity and action of the plier heads 310, 316 about the third hinge 322.

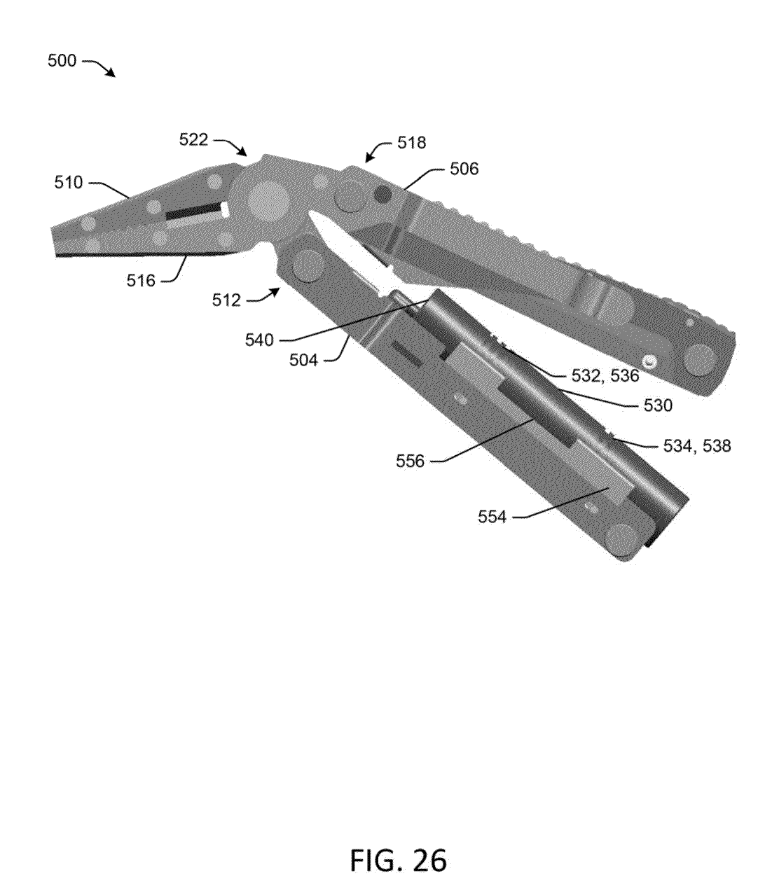

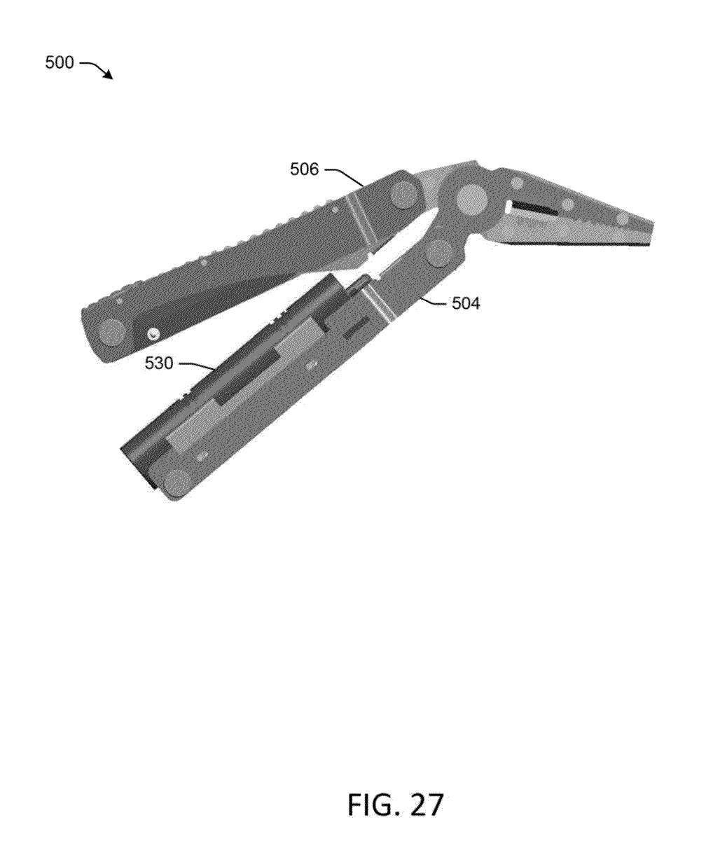

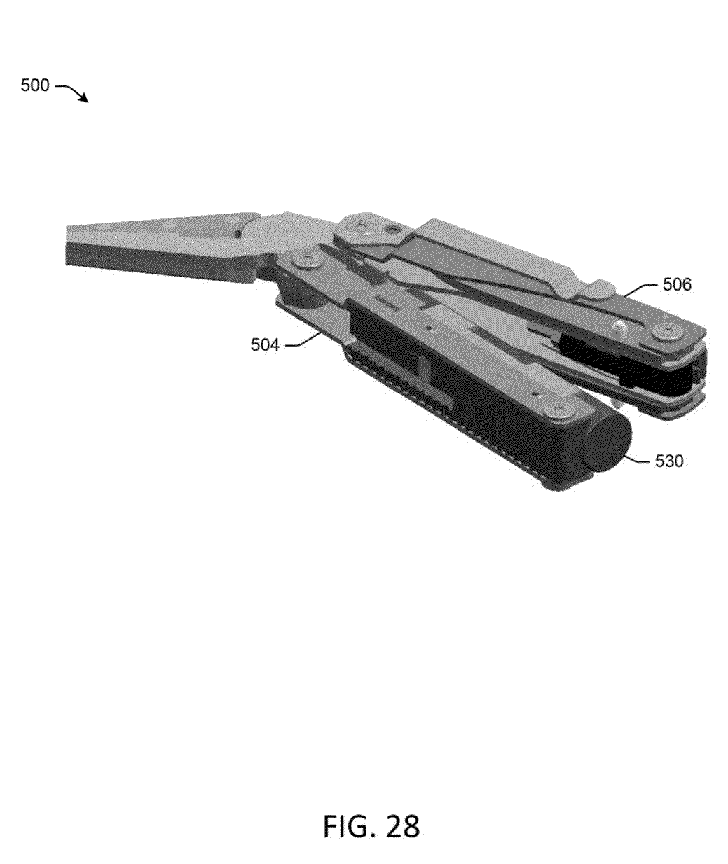

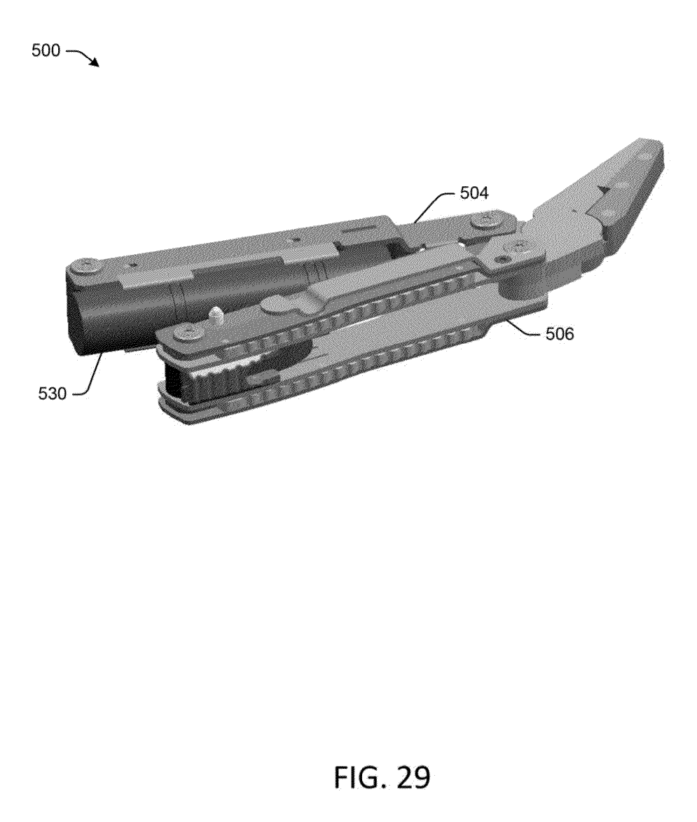

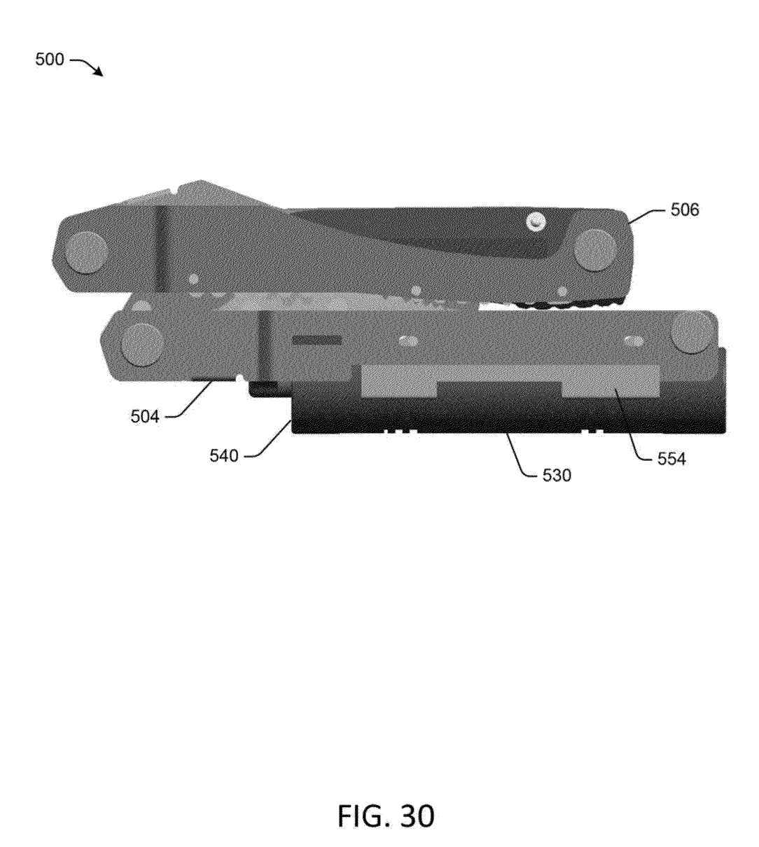

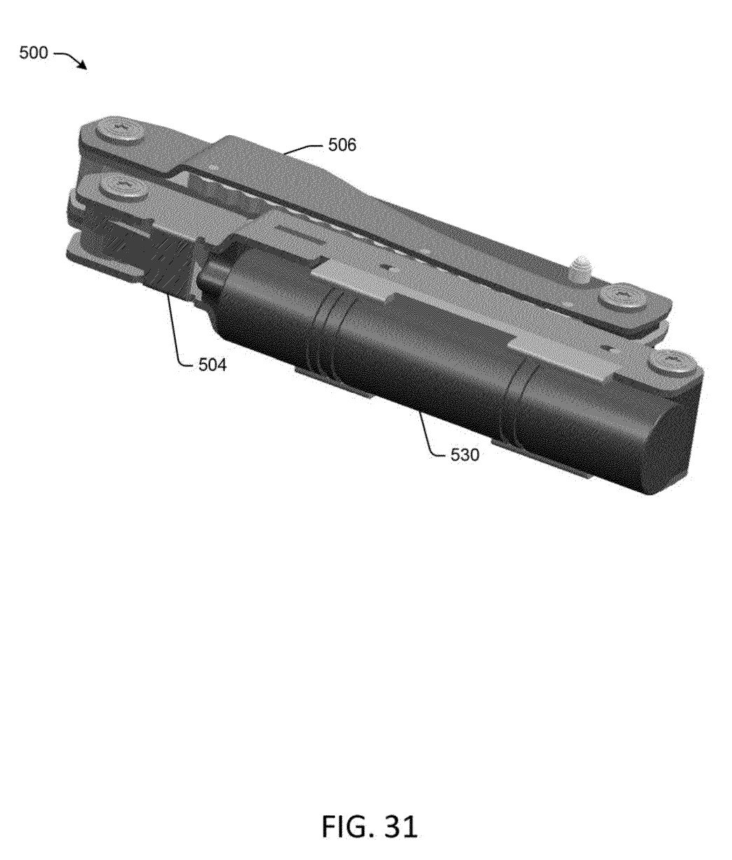

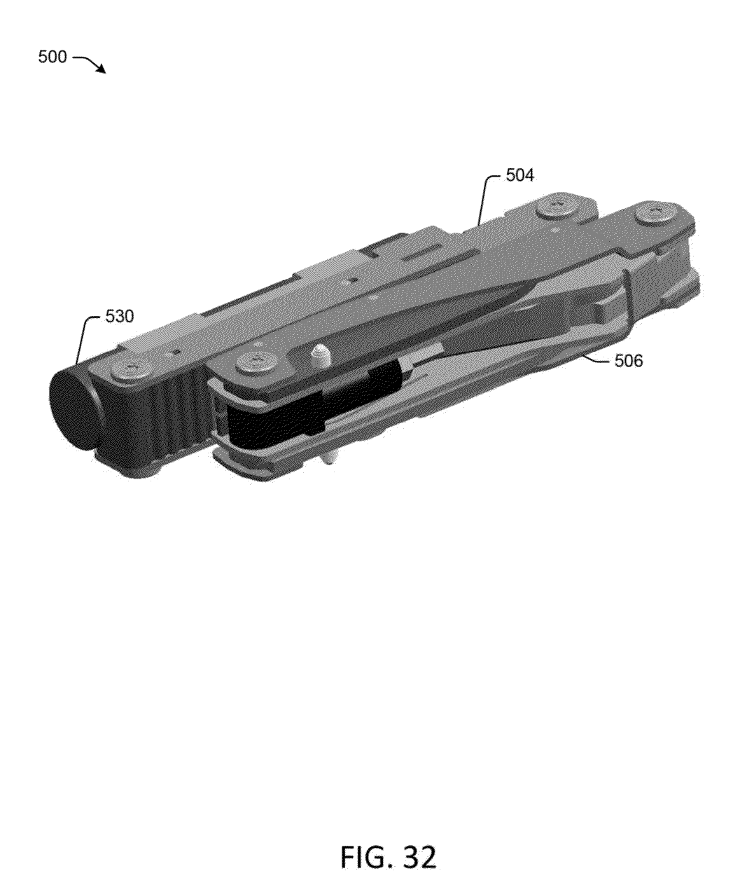

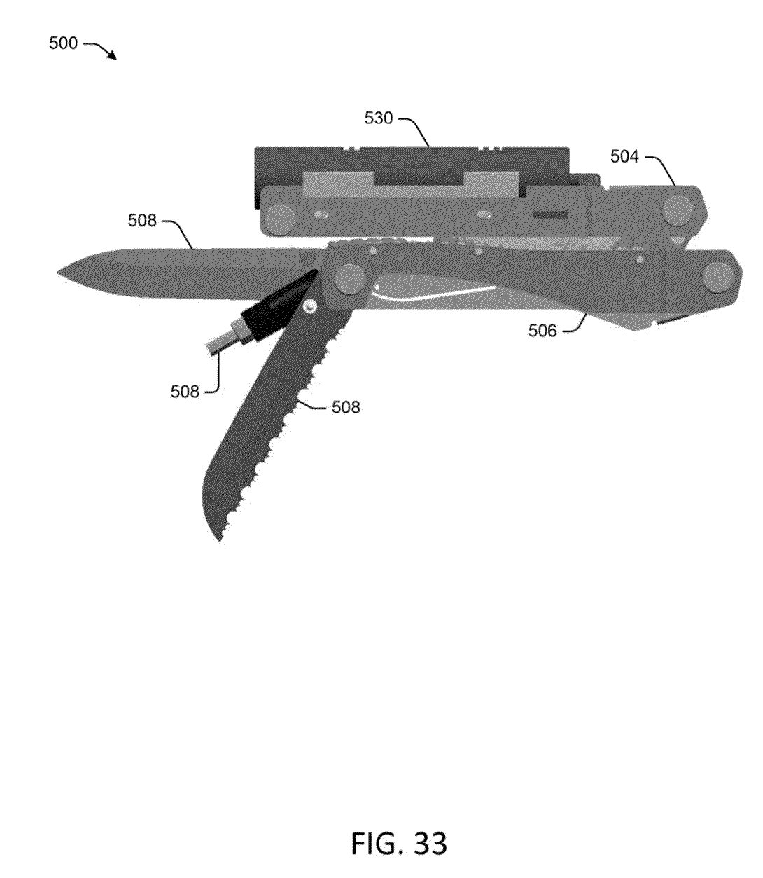

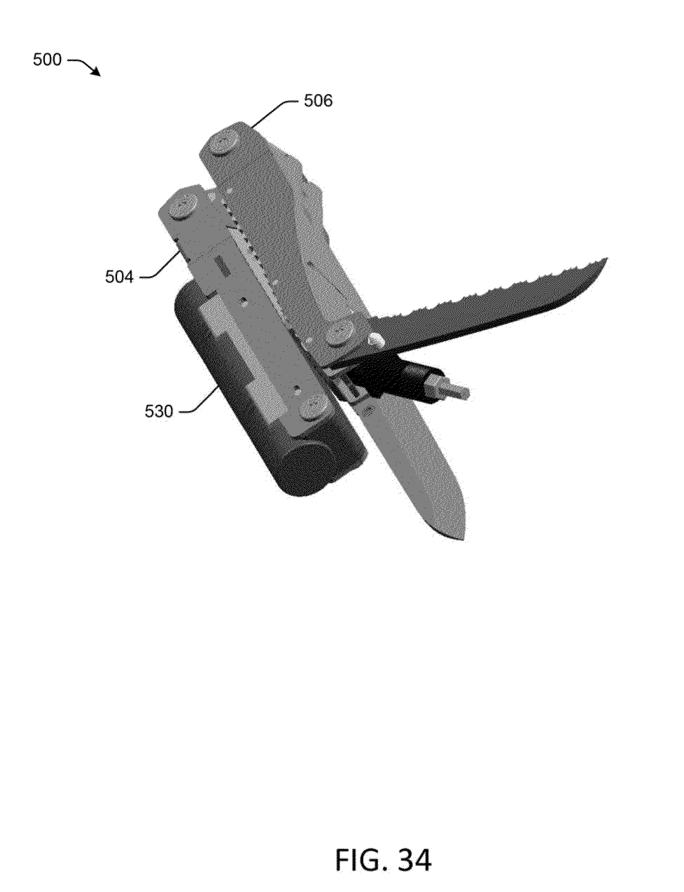

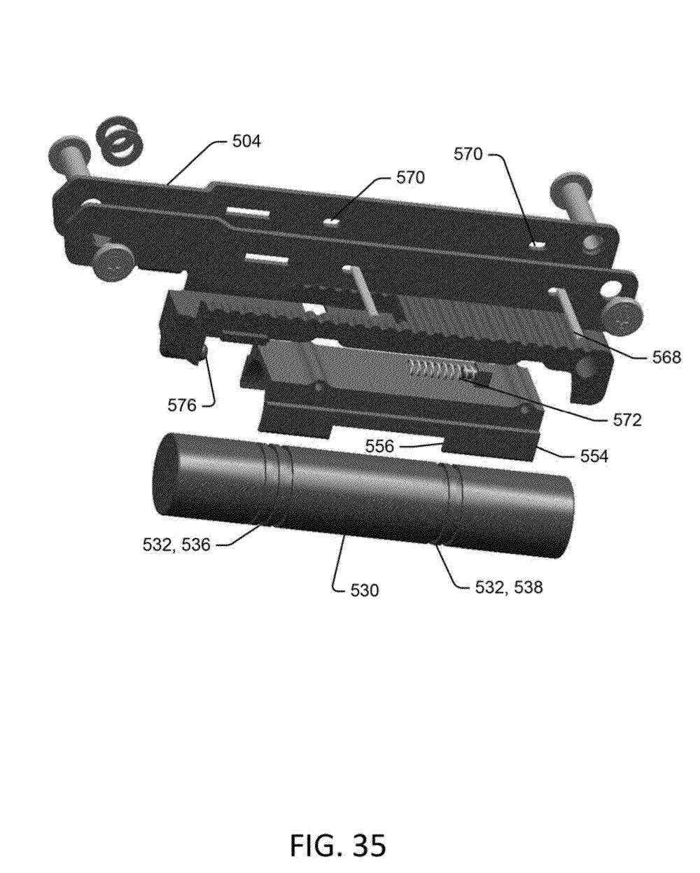

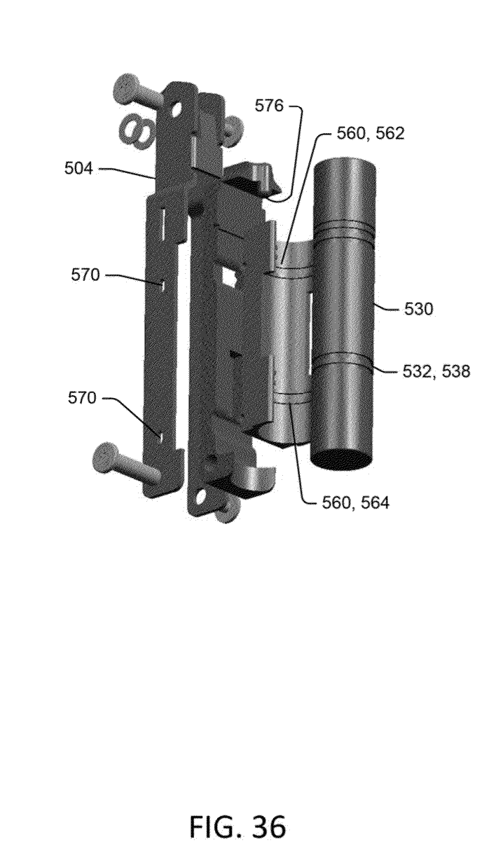

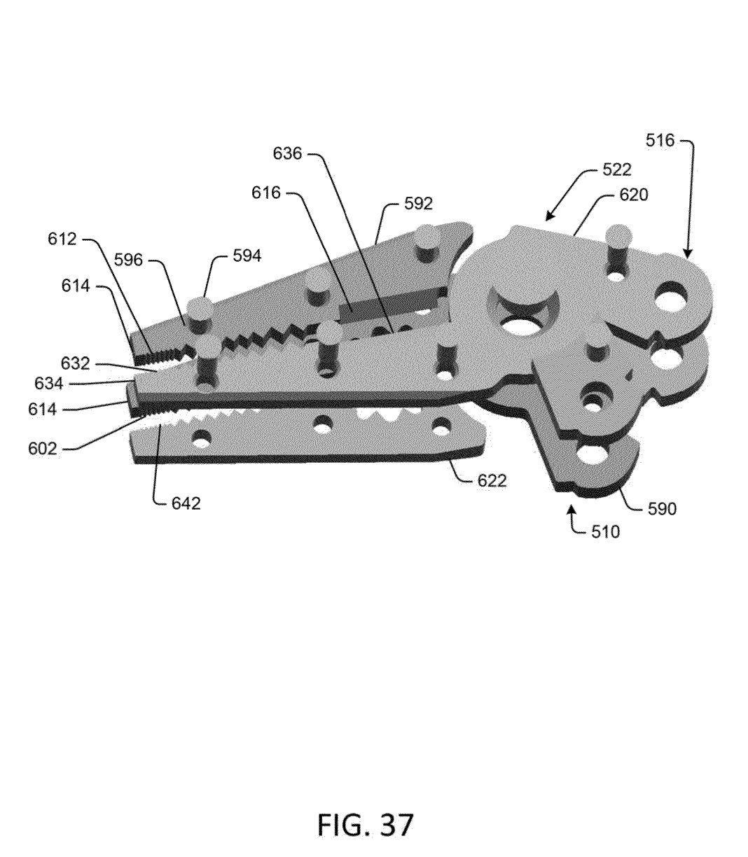

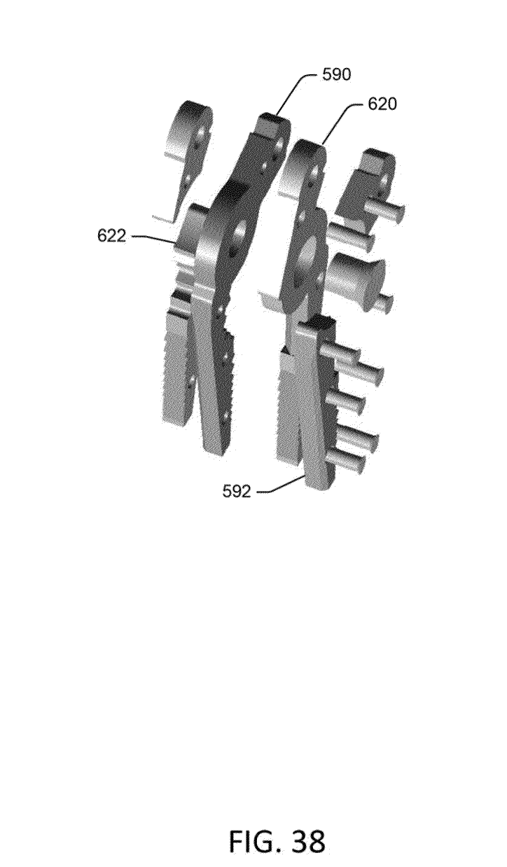

FIGS. 26-38 depict various views of a multipurpose hand held tool 500 in accordance with an embodiment of the disclosure. Specifically, FIG. 26 depicts a front view of the multipurpose tool 500 with handles in an open position, FIG. 27 depicts a back view of the multipurpose tool 500 with the handles in the open position, FIG. 28 depicts a perspective view of the multipurpose tool 500 with the handles in the open position, FIG. 29 depicts a perspective view of the multipurpose tool 500 with the handles in the open position, FIG. 30 depicts a back view of the multipurpose tool 500 with the handles in a closed position, FIG. 31 depicts a perspective view of the multipurpose tool 500 with the handles in the closed position, FIG. 32 depicts a perspective view of the multipurpose tool 500 with the handles in the closed position. FIG. 33 depicts a front view of the multipurpose tool 500 with the handles in the closed position and component tools in a deployed position, FIG. 34 depicts a perspective view of the multipurpose tool 500 with the handles in the closed position and component tools in a deployed position, FIG. 35 depicts an exploded perspective view of a handle, a coupling mechanism, and a detachable accessory of the multipurpose tool 500, FIG. 36 depicts an exploded perspective view of the handle, the coupling mechanism, and the detachable accessory of the multipurpose tool 500, FIG. 37 depicts an exploded perspective view of a plier head assembly of the multipurpose tool 500, and FIG. 38 depicts an exploded perspective view of the plier head assembly of the multipurpose tool 500. Collectively referring to FIGS. 26-38, and by way of example, the multipurpose tool 500 may include a first handle 504 and a second handle 506. The multipurpose tool 500 may also include component tools 508 connected to the first handle 504 or the second handle 506. In some examples, the component tools 508 may be rotatably connected to the first handle 504 or the second handle 506 by fasteners. Accordingly, the component tools 508 may be rotated from a storage position, as shown in FIG. 30, to one or more deployed positions, as shown in FIG. 33.

In some examples, the first handle 504 may be rotatably coupled to a first plier head 510 at a first hinge 512, and the second handle 506 may be rotatably coupled to a second plier head 516 at a second hinge 518. Additionally, the first plier head 510 and the second plier head 516 may be rotatably coupled at a third hinge 522. In this manner, the first plier head 510 and the second plier head 516 may rotate relative to one another about the third hinge 522 to provide traditional pliers action. Furthermore, the first handle 504 and the second handle 506 may be rotated relative to the first plier head 510 and the second plier head 516, respectively, about the first hinge 512 and the second hinge 518, respectively. In this manner, the handles 504, 506 may be rotated relative to the plier heads 510, 516 such that the plier heads 510, 516 may be in a deployed position, as shown in FIG. 26, or a storage position, as shown in FIG. 30.

In certain aspects, the first plier head 510 and the second plier head 516 may have an angled configuration relative to the handles 504, 506. In other words, when the handles 504, 506 are in the open position such that the plier heads 510, 516 are deployed for use, the handles 504, 506 are asymmetrically positioned with respect to the plier heads 510, 516. In some aspects, a length of the first handle 504 may be greater than a length of the second handle 506 in order to better accommodate the angled configuration of the plier heads 510, 516. In this manner, the angled configuration may provide improved visibility of an object being grasped due to the asymmetric position of the handles 504, 506 with respect to the plier heads 510, 516.

In certain examples, the multipurpose tool 500 may include a flashlight 530 detachably coupled to the first handle 504. The flashlight 530 may be cylindrical in shape. Alternatively, the flashlight 530 may assume other shapes that provide a regular or irregular cross-section. In some aspects, the flashlight 530 may include one or more grooves 532 for coupling the flashlight 530 to the first handle 504. The flashlight 530 may include a plurality of grooves 532 arranged parallel to one another along the flashlight 530. The plurality of grooves 532 may be spaced along an axis of the flashlight 530, and each groove 532 may extend circumferentially around an outer surface of the flashlight 530. In some aspects, the flashlight 530 may include a first plurality of grooves 536 axially spaced apart from a second plurality of grooves 538. The flashlight 530 also may include an activation button 540 that may be activated by contact such that the flashlight 530 provides light or stops providing light. In certain aspects, the activation button 540 may be located at one end of the flashlight 530. Alternatively, the activation button 540 may be located on a side of the flashlight 530 or elsewhere on the outer surface of the flashlight 530. In some aspects, the activation button 540 may be accessible when the flashlight 530 is attached to the multipurpose tool 500. Specifically, the activation button 540 may be accessible when the first handle 504 is in the open position and also when the first handle 504 is in the closed position.

In some aspects, the flashlight 530 may be detachably coupled to the first handle 504 by a coupling mechanism 550. The coupling mechanism 550 may include a carrier 554, and a portion of the flashlight 530 may be removably received within the carrier 554. In certain aspects, the portion of the flashlight 530 may be removably received within the carrier 554 by a snap fit or an interference fit. Accordingly, the carrier 554 may have a cupped shape that is sized slightly smaller than the flashlight 530 such that the carrier 554 may retain the flashlight 530. The carrier 554 may extend around at least half of a circumference of the flashlight 530 to ensure that the flashlight 530 is sufficiently retained. In some aspects, the carrier 554 may include a cutout 556 exposing more than half of the circumference of the flashlight 530 for ease of grasping the flashlight 530 for removal from the carrier 554. In certain aspects, the carrier 554 may include one or more ribs 560 on an inner surface of the carrier. The one or more ribs 560 may be removably received within the one or more grooves 532 of the flashlight 530 to prevent the flashlight 530 from moving axially within the carrier 554. The carrier 554 may include a plurality of ribs 560 arranged parallel to one another along the carrier 554. The plurality of ribs 560 may be spaced along an axis of the carrier 554, and each rib 560 may extend circumferentially around an outer surface of the flashlight 530. In some aspects, the carrier 554 may include a first plurality of ribs 562 axially spaced apart from a second plurality of ribs 564. In this manner, the coupling mechanism 550 may incorporate the flashlight into the multipurpose tool 500, while allowing for quick removal of the flashlight 530 for subsequent use apart from the multipurpose tool 500.

In certain aspects, the carrier 554 may be slideably connected to the first handle 504 such that the carrier 554 may be able to slide from a first position to a second position along a length of the first handle 504. Accordingly, when the flashlight 530 is received within the carrier 554, the flashlight 530 may be able to slide along the length of the first handle 504. In some aspects, the carrier 554 may be slideably connected to the first handle 504 by one or more pins 568 slideably received within one or more slots 570 defined in the first handle 504. Accordingly, the first position and the second position of the carrier 554 relative to the first handle 504 may be defined by the location and size of the slots 570. In certain aspects, the coupling mechanism 550 may further include a spring 572 biasing the carrier 554 toward the first position. The spring 572 may be a compression spring contacting the carrier 554 and the first handle 504 such that the carrier 554 is biased toward the first position. Accordingly, the carrier 554 remains in the first position unless force is applied to the carrier 554 or flashlight 530 to overcome the resistance of the spring 572 and move the carrier 554 to the second position. In some aspects, the first handle 504 may include an activation protrusion 576 that contacts the activation button 540 of the flashlight 530 when the carrier 554 is in the second position. Such contact may activate the activation button 540 such that the flashlight 530 provides light or stops providing light. In this manner, the coupling mechanism 550 may incorporate the flashlight into the multipurpose tool 500, while allowing for quick activation or deactivation of the flashlight 530 when the flashlight is coupled to the first handle 504. Furthermore, the coupling mechanism may allow the flashlight 530 to be activated or deactivated when the first handle 504 is in the open position or the closed position.

In certain examples, as shown in FIGS. 37 and 38, each of the first plier head 510 and the second plier head 516 may have a multi-layered configuration. The first plier head 510 may include a first layer 590 and a second layer 592. The first layer 590 and the second layer 592 of the first plier head 510 may be connected by fasteners 594. The fasteners 594 may be received within corresponding holes 596 defined in each of the first layer 590 and the second layer 592. In certain aspects, the fasteners 594 may be press-fit pins, rivets, or other known fasteners. The first layer 590 may include a plurality of teeth 602 positioned between the third hinge 522 and a distal tip 604 of the first layer 590. The second layer 592 may include a plurality of teeth 612 positioned between the third hinge 522 and a distal tip 614 of the second layer 592. The second layer 592 also may include a cutting tool 616 positioned between the third hinge 522 and the plurality of teeth 612 of the second layer 592. In this manner, the plurality of teeth 612 of the first layer 590 may extend over the cutting tool 616 of the second layer 592 of the first plier head 510. The second plier head 516 similarly may include a first layer 620 and a second layer 622. The first layer 620 and the second layer 622 of the second plier head 516 may be connected by fasteners 594. The fasteners 594 may be received within corresponding holes 596 defined in each of the first layer 620 and the second layer 622. The first layer 620 may include a plurality of teeth 632 positioned between the third hinge 522 and a distal tip 634 of the first layer 590. The first layer 620 also may include a cutting tool 636 positioned between the third hinge 522 and the plurality of teeth 632 of the first layer 620. The second layer 622 may include a plurality of teeth 642 positioned between the third hinge 522 and a distal tip 644 of the second layer 622. In this manner, the plurality of teeth 642 of the second layer 622 may extend over the cutting tool 636 of the first layer 620 of the second plier head 516. Accordingly, each of the first plier head 510 and the second plier head 516 may incorporate a plurality of teeth and a cutting tool without requiring overly complex machining of the plier heads.

In some aspects, one or more of the plurality of teeth 602, 612, 632, 642 may have a graduated configuration. In other words, the teeth 602, 612, 632, 642 may be smaller towards the distal tip 604, 614, 634, 644, respectively, and gradually increase in size towards the third hinge 522. In other aspects, one or more of the plurality of teeth 602, 612, 632, 644 may vary in size according to a stepped configuration. That is, the teeth 602, 612, 632, 642 may include groupings of teeth that are the same size, and the size of the teeth in each grouping may increase from the distal tip 604, 614, 634, 644 towards the third hinge 522. In is understood that the graduated configuration or stepped configuration of the teeth may be incorporated into one or both of the first plier head 510 and the second plier head 516 whether the plier heads 510, 516 have a multi-layered configuration or a single layer configuration. By providing the teeth 602, 612, 632, 642 in a graduated configuration or stepped configuration, the plier heads 510, 516 may be able to grasp objects of many different sizes and shapes.

Although specific embodiments of the disclosure have been described, one of ordinary skill in the art will recognize that numerous other modifications and alternative embodiments are within the scope of the disclosure. Further, while embodiments of the disclosure have been described with respect to specific examples of multipurpose tool configurations, it will be appreciated that numerous other multipurpose tool configurations are within the scope of this disclosure. Still further, while embodiments of the disclosure have been described with respect to specific types of multipurpose tools, one should appreciate that numerous other types of multipurpose tools are within the scope of this disclosure.

Although embodiments have been described in language specific to structural features, it is to be understood that the disclosure is not necessarily limited to the specific features described. Rather, the specific features are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features and/or elements. Thus, such conditional language is not generally intended to imply that features and/or elements are in any way required for one or more embodiments.

That which is claimed is:

1. A multipurpose hand held tool, comprising:
a handle comprising an outer surface and an inletted recess defined in the outer surface;
a retention clip mounted on the outer surface of the handle, wherein a portion of the retention clip extends over the inletted recess; and
an accessory tool detachably received within the inletted recess and releaseably retained by the retention clip.

2. The multipurpose hand held tool of claim 1, wherein the retention clip comprises a protrusion extending inwardly toward the inletted recess, wherein the accessory tool comprises a retention aperture, and wherein the protrusion is detachably received within the retention aperture.

3. The multipurpose hand held tool of claim 1, wherein the portion of the retention clip that extends over the inletted recess is cantilevered over the inletted recess.

4. The multipurpose hand held tool of claim 1, wherein the accessory tool comprises a multi-hex aperture configured to engage and drive male hexagonal features of multiple sizes.

5. The multipurpose hand held tool of claim 1, wherein the accessory tool comprises a bottle opener.

6. The multipurpose hand held tool of claim 1, wherein ends of the accessory tool are tapered for use as a screwdriver or a pry bar.

7. A multipurpose hand held tool, comprising:
a handle;
a rotatable tool connected to the handle, the rotatable tool comprising a base, an arm, and at least one cutout positioned about an axis of the base;
a pivotable catch comprising a locking tab for releaseably engaging the at least one cutout; and
a leaf spring biasing the locking tab toward the base of the rotatable tool.

8. The multipurpose hand held tool of claim 7, wherein the rotatable tool comprises a plurality of cutouts circumferentially spaced about the axis of the base, wherein each of the plurality of cutouts is configured to lock the rotatable tool at a different angle relative to the handle.

9. The multipurpose hand held tool of claim 8, wherein one of the plurality of cutouts is configured to lock the rotatable tool at a 90-degree angle relative to the handle.

10. The multipurpose hand held tool of claim 7, wherein the pivotable catch further comprises a release lever, and wherein the leaf spring contacts the release lever.

11. The multipurpose hand held tool of claim 10, wherein the pivotable catch further comprises a pivot hole positioned between the release lever and the locking tab.

12. The multipurpose hand held tool of claim 7, wherein the rotatable tool further comprises a first stop and a second stop positioned about the axis of the base, wherein the first stop limits rotation of the rotatable tool in a first direction, and wherein the second stop limits rotation of the rotatable tool in a second direction.

13. A multipurpose hand held tool, comprising:
a first handle rotatably coupled to a first plier head at a first hinge;
a second handle rotatably coupled to a second plier head at a second hinge, wherein the first plier head and the second plier head are rotatably coupled at a third hinge; and
a flashlight detachably coupled to the first handle by a coupling mechanism.

14. The multipurpose hand held tool of claim 13, wherein the coupling mechanism comprises a carrier, and wherein a portion of the flashlight is removably received within the carrier.

15. The multipurpose hand held tool of claim 13, wherein the portion of the flashlight is removably received within the carrier by a snap fit.

16. The multipurpose hand held tool of claim 14, wherein the flashlight comprises one or more grooves, wherein the carrier comprises one or more ribs, and wherein the one or more ribs of the carrier are removably received within the one or more grooves of the flashlight.

17. The multipurpose hand held tool of claim 14, wherein the carrier is slideably connected to the first handle such that the carrier is configured to slide from a first position to a second position along a length of the first handle.

18. The multipurpose hand held tool of claim 17, wherein the carrier is slideably connected to the first handle by one or more pins slideably received within one or more slots defined in the first handle.

19. The multipurpose hand held tool of claim 17, wherein the coupling mechanism further comprises a spring biasing the carrier toward the first position.

20. The multipurpose hand held tool of claim 17, wherein the flashlight comprises an activation button, wherein the first handle comprises an activation protrusion, and wherein the activation protrusion of the first handle contacts the activation button of the flashlight when the carrier is in the second position.
